SEQUENCE LISTING (1 sequence)

SEQ ID NO: 1 - protein, 18 aa, Artificial Sequence
  Abeta monomer mimic sequence
AALVFFAEDAAAIIALAV

(19) United States
(12) Patent Application Publication
(10) Pub. No.: US 2017/0212981 A1
(43) Pub. Date: Jul. 27, 2017

(54) METHODS FOR SCREENING THERAPEUTIC AGENT FOR PROTEIN CONFORMATIONAL DISEASES

(71) Applicant: SOOKMYUNG WOMEN'S UNIVERSITY INDUSTRY ACADEMIC COOPERATION FOUNDATION, Seoul (KR)

(72) Inventor: Si Hyun HAM, Seoul (KR)

(21) Appl. No.: 15/222,855

(22) Filed: Jul. 28, 2016

(30) Foreign Application Priority Data
Jan. 27, 2016 (KR) 10-2016-0010292

(51) Int. Cl. G06F 19/16; G06F 17/11

(52) U.S. Cl. CPC G06F 19/16; G06F 17/11

(57) ABSTRACT

Provided is a screening method of a composition for preventing or treating various protein conformational diseases including Alzheimer's disease, and the screening method of a composition for diagnosing protein conformational diseases. The screening method according to the present invention can rapidly mass-screen the composition for treating or diagnosing the protein conformational diseases in silico with highly reliability based on the binding of the peptide of the present invention and the test material.

### CROSS-REFERENCE TO RELATED APPLICATIONS

This application claims priority to Korean Patent application No. 10-2016-0010292 filed on Jan. 27, 2016, the entire contents of which are incorporated herein by reference.

### REFERENCE TO A SEQUENCE LISTING

The Sequence Listing filed electronically herewith is also hereby incorporated by reference in its entirety (File Name: OP2016-022US_sequence_ST25.txt; Date Created: Jul. 28, 2016; File Size: 579 bytes)

### BACKGROUND OF THE INVENTION

1. Field of the Invention

The present invention relates to a screening method of composition for treating or diagnosing protein conformational diseases using peptide mimicking a three-dimensional structure of Aβ oligomer.

2. Description of the Related Art

Protein misfolding diseases represent a group of disorders that have tissue deposition of β-sheet-rich, filamentous protein aggregates, known as amyloid fibrils in common. Alzheimer's disease (AD) is one of the most studied protein misfolding diseases in which amyloid β-peptide (Aβ) aggregates, forming extracellular neuritic plaques in the brain. AD affects well over 35 million worldwide, and this number is expected to grow dramatically as the population ages. Amyloidogenic proteins and peptides can adopt a number of distinct assembly states, and a key issue is which of these assembly states are more closely associated with pathogenesis. Fibrillization of Aβ resulting in plaque deposition has long been regarded as the cause of neurodegeneration in AD. However, recent data suggest that oligomeric soluble Aβ is principally responsible for the pathogenesis of AD, and its levels are more important in disease progression. The concept of Aβ intermediate involvement in the development of AD has been used to explain why amyloid pathology, defined by Aβ plaque load, is only poorly correlated with clinical AD presentation, effectively suggesting that amyloid plaque is a relatively nontoxic aggregated form of Aβ. Hence, there is an urgent need for the development of detection methods that are able to identify a variety of morphologically distinct Aβ peptides.

Aβ plaques have been detected using a number of fibril specific dyes, such as Congo Red (CR) or Thioflavin T(ThT), which preferably bind to mature amyloid fibrils. Neither CR nor ThT was suitable for in vivo use; nonetheless, they serve as the basis for development of improved imaging agents to detect amyloid accumulation, which gave rise to compounds such as PiB. Despite extensive research for many decades, it was only until recently that a brain imaging agent, Florbetapir, was approved by the Food and Drug Administration (FDA) to evaluate AD. In recent years, however, there has been a paradigm shift with numerous reported efforts involved in the development of effective methods for Aβ oligomers detection, including oligomer-specific antibody, oligomer-specific peptide-FlAsh system, peptide-based fluorescent protein, as well as the ELISA method. Yet, these detection methods often involve laborious construction methods, complicated instrumentation, or a long testing time, which make them inconvenient to use. In addition, their inability to cross the blood-brain barrier (BBB) makes them inappropriate for in vivo application.

Small fluorescent molecular probes, which yield high sensitivity and easy visibility, would offer a convenient and straightforward approach for the detection of Aβ oligomers. One of the reported oligomer specific fluorescence sensors showed the capability of distinguishing soluble Aβ from Aβ of ordered conformation but fell short of discriminating oligomers from fibrils and lack demonstration of biological application capabilities.

Here, the present inventors describe BD-Oligo, a novel fluorescent chemical probe that preferentially recognizes Aβ oligomeric assemblies over monomers or fibrils, by using diversity-oriented fluorescence library (DOFL) screening and computational techniques. DOFL was generated in house through combinatorial synthesis by the modification of side chains of different fluorescent dye backbones and has proven its versatility in sensor development. BD-Oligo demonstrates a dynamic oligomer-monitoring ability during Aβ peptide fibrillogenesis, as Aβ was induced to form oligomers and eventually fibrils over time. More importantly, BD-Oligo also shows BBB penetration with capabilities of staining Aβ oligomers in vivo.

Throughout this application, various patents and publications are referenced and citations are provided in parentheses. The disclosure of these patents and publications in their entities are hereby incorporated by references into this application in order to more fully describe this invention and the state of the art to which this invention pertains.

### SUMMARY OF THE DISCLOSURE

The inventors of the present invention made the research effort for screening a therapeutic agent of various protein conformational diseases including Alzheimer's disease and developing a target for diagnosis having high reliability of the diseases. As a result, in the case of monitoring whether binding to a specific peptide reproducing a 3D feature of amyloid 3 (AP) oligomer molecules, the inventors can find a material which is specifically bound to Aβ oligomer known as a main cause of neurodegeneration in Alzheimer's disease and the like and discover that the found material may be applied as a composition for preventing or treating protein conformational diseases inhibiting the activity of Aβ oligomer; and a composition for diagnosis which determines a risk of the protein conformational disease by accurately measuring a level of Aβ oligomer in the body, thereby completing the present invention.

Therefore, an object of the present invention is to provide a screening method of a composition for preventing or treating protein conformational diseases.

Another object of the present invention is to provide a screening method of a composition for diagnosing protein conformational diseases.

Other objects and advantages of the present invention will become apparent from the following detailed description together with the appended claims and drawings.

### Effect of the Invention

Features and advantages of the present invention are as follows.

(a) The present invention provides the screening method of the composition for preventing or treating various protein conformational diseases including Alzheimer's disease and the screening method of the composition for diagnosing the diseases.
(b) The method of the present invention can rapidly mass-screen the composition for treating or diagnosing the protein conformational diseases in silico with high reliability based on the binding of the peptide of the present invention and the test material.

### BRIEF DESCRIPTION OF THE DRAWINGS

FIGS. 1A and 1B depict Conformational specificity of BD-Oligo. FIG. 1A depicts Chemical structure of BD-Oligo, and FIG. 1B depicts Emission spectra of BD-Oligo alone and when incubated with monomers, oligomers, and fibrils of Aβ (λex=530 nm, dye 5 M, Aβ 20 μM).

FIGS. 2A-2D depict Biophysical characterization of oligomer-specific response. FIG. 2A depicts Time-dependent fibril formation of Aβ was monitored by ThT, whereas BD-Oligo detects on-fibril pathway oligomers (dye 5 M, Aβ 20 μM), FIG. 2B depicts Kinetics of oligomer-specific immunoreactivity during fibrillogenesis, as probed by oligomer-specific A11 antibody and 6E10 antibody against Aβ, FIG. 2C depicts Pelleting assay for Aβ at various time points after fibril formation time course has been initiated, and FIG. 2D depicts Transmission electron microscopy (TEM) images of Aβ at day 0, day 1, and day 4 of fibrillogenesis.

FIG. 3 depicts BD-Oligo complex with Aβ oligomers. FIG. 3a depicts Aβ oligomer from X-ray (4NTR) from ref 29. F19 and V36 residues are shown in yellow, FIG. 3b depicts Optimized BD-Oligo structure at the B3LYP/6-31G* level, and FIG. 3c depicts Simulated complex structure of BD-Oligo and Aβ oligomer.

FIGS. 4A and 4B depict Ex vivo binding of BD-Oligo in 18 month old AD mouse brains. (a, b, and c) Fluorescence in the APP/PS 1 mouse brain injected with BDOligo using the channel for 6E10/4G8 labeling, BDOligo labeling, and the merged image, respectively. BD-Oligo fluorescence was present in the brain 24 h after an ip injection of BD-Oligo (see b), which colocalized with the Aβ labeling (see c). Arrows indicate plaques with colocalization. (d, e, and f) Fluorescence in the APP/PS1 mouse brain injected saline alone using the channel for 6E10/4G8 labeling, BD-Oligo labeling, and the merged image, respectively. There are no plaques seen in the BD-Oligo channel in the control saline-injected mice, indicating the specificity of the BDOligo oligomer labeling. Scale bar 100 μm.

FIGS. 5A and 5B depict Characterization of monomers, oligomers and fibrils formed from synthetic Aβ1-40 peptide. (a) Dot blots of Aβ probed by oligomer-specific A11 and 6E10 antibodies; (b) Emission spectra of ThT alone and when incubated with monomers, oligomers and fibrils of Aβ (λex=440 nm, dye: 5 μM, Aβ: 20 μM).

FIGS. 6A and 6B depict Spectra and spectral information of BD-Oligo. FIG. 6A depicts absorbance and emission spectra of BD-Oligo; and FIG. 6B deoucts absorbance maximum, emission maximum and quantum yield of BD-Oligo, measured in DMSO.

FIG. 7 depicts BD-Oligo binding constant (Aβ oligomers: 20 μM, λex=530 nm), F is the fluorescence intensity of BD-Oligo at 580 nm after binding with Aβ oligomers; and F0 is the fluorescence intensity of BD-Oligo at 580 nm before binding with Aβ oligomers.

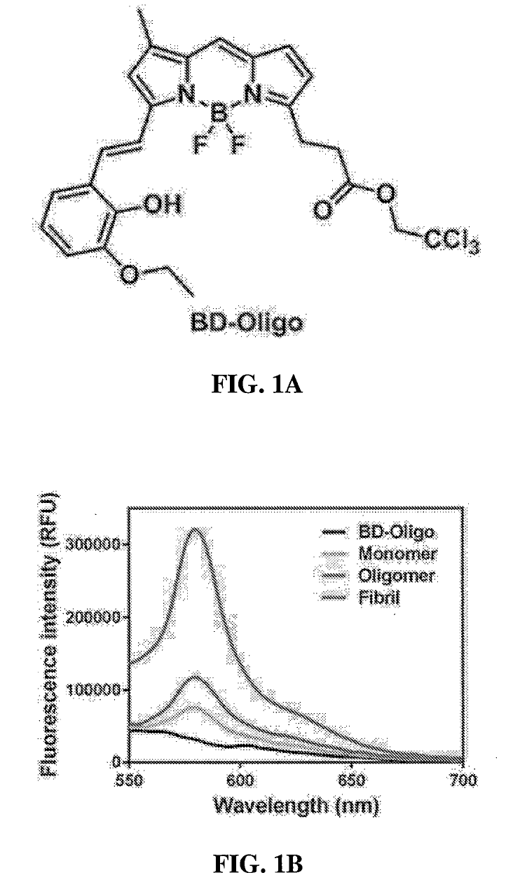

### DETAILED STATISTICS FOR FIGURE S3

| Best-fit values | |
|---|---|
| Bmax | 7.886 |
| Kd | 0.4819 |
| NS | −0.2092 |
| Background | −1.172 |
| Std. Error | |
| Bmax | 0.3667 |
| Kd | 0.07957 |
| NS | 0.09903 |
| Background | 0.2375 |
| 95% Confidence Intervals | |
| Bmax | 7.088 to 8.685 |
| Kd | 0.3085 to 0.6553 |
| NS | −0.4250 to 0.006613 |
| Background | −1.690 to −0.6546 |
| Goodness of Fit | |
| Degrees of Freedom | 12 |
| R2 | 0.9958 |
| Absolute Sum of Squares | 0.1423 |
| Sy.x | 0.1089 |
| Number of points | 16 |
| Analyzed | |

FIG. 8 depicts Time-dependent fibril formation of Aβ was monitored by ThT, whereas BD-Oligo detects on-fibril pathway oligomers (dye: 5 μM, Aβ: 20 μM). F is the fluorescence intensity of BD-Oligo at 580 nm after binding with Aβ oligomers; F0 is the fluorescence intensity of BD-Oligo at 580 nm before binding with Aβ oligomers.

FIG. 9 depicts Biophysical characterization of oligomer-specific response. CD spectra for Aβ at various time-points, after fibril formation time course is initiated.

FIG. 10 depicts Site-directed thermodynamics analysis of the BD-Oligo complex with Aβ oligomer (Aβ17-36). Residue-specific free energy values (Δf) are plotted for the free energy of Aβ oligomer with BD-Oligo binding (fcomplex) relative to that of Aβ oligomer without BD-Oligo (fAβ oligomer) for each residue.

### DETAILED DESCRIPTION OF EMBODIMENTS

An aspect of the present invention provides a screening method of a composition for preventing or treating protein conformational diseases comprising the following steps:

(a) contacting peptide represented by the following Formula 1 and a test material to be analyzed;

[(X₁)ₙ-X₃-X₄-Phe-X₅-X₆-X₇-X₈-(X₂)ₙ-X₉-X₁₀-X₁₁-X₁₂-X₁₃-X₁₄-Val]ₘ Formula 1

in Formula 1, X₁ and X₂ are independently selected from the group consisting of ALA, GLY, and SER, respectively, X₃ to X₁₄ are independently selected from the group consisting of ALA, GLU, ILE, VAL, ASP, and LEU, respectively, and n is an integer of 2 to 4, and m is an integer of 3 to 12; and

(b) measuring binding of the peptide and the test material to be analyzed, in which when the binding of the peptide and the test material to be analyzed is detected, the test material is determined as the composition for preventing or treating the protein conformational diseases.

The inventors of the present invention made the research effort for screening a therapeutic agent of various protein conformational diseases including Alzheimer's disease and developing a target for diagnosis having high reliability of the diseases. As a result, in the case of monitoring whether binding to a specific peptide reproducing a 3D feature of amyloid β (Aβ) oligomer molecules, the inventors can find a material which is specifically bound to the Aβ oligomer known as a main cause of neurodegeneration in Alzheimer's disease and the like and discover that the found material may be applied as a composition for preventing or treating protein conformational diseases inhibiting the activity of the Aβ oligomer; and a composition for diagnosis which determines a risk of the protein conformational disease by accurately measuring a level of Aβ oligomer in the body.

According to the present invention, since the material bound to the peptide of the present invention is specifically bound to the Aβ oligomer corresponding to an intermediate in the fibrillation of Aβ and does not react with a monomer of Aβ and fibril without toxicity, the present invention may provide a screening method and a diagnosing method for a therapeutic agent with higher reliability.

The term of the test material used while mentioning the screening method of the present invention means an unknown material which is specifically bound to the Aβ oligomer or used in screening in order to examine whether to have an effect on the activity through binding. The test material includes a compound, nucleotide, peptide, and natural extracts, but is not limited thereto. Subsequently, in an environment where the test material is treated, the binding between the peptide of the present invention and the test material is measured. The binding may be measured by various methods known in the art, and as a result, when the binding between the peptide of the present invention and the test material is significantly formed, the test material may be determined as the composition for preventing or treating protein conformational diseases.

In this specification, the term “measurement” means including a series of deductive and inductive processes deriving an unknown value by using specific data, and thus, is used to have the same meaning as the meanings of calculation, prediction, investigation, and determination. Accordingly, in the present invention, the term “measurement” includes experimental measurement, computational calculation in silico, and establishment of a relationship between a plurality of variables based thereon.

In this specification, the term “peptide” means a series of macromolecules formed by binding amino acid residues by a peptide bond. In the peptide, a 3D form and a state change trend is influenced by a linear molecule consisting of a continuous binding of amino acid units, the entire size, charge and hydrophobicity of all or each constituent residue(s), whether to form covalent or non-covalent bonds, and the like, and when the form and trend are abnormal, protein aggregation and the like are caused to become causes of various protein conformational diseases (PCDs).

In this specification, the term “protein aggregation” means forming aggregates by accumulating and massing misfolded proteins within or outside cells. The term “misfolding” means that polypeptide is not normally folded to obtain a 3D structure having a unique function and activity of the protein. Since the misfolding and the aggregation of the proteins cause the lack of normal proteins or accumulate abnormal proteins to increase toxicity and thus cause various PCDs, the method of the present invention targeting Aβ oligomer as an intermediate of the Aβ aggregation provides important information to establish development strategy of a therapeutic composition of such diseases and predict the risk of diseases.

In this specification, the term “treating” means (a) inhibiting development of disorders, diseases, or symptoms, (b) reduction of disorders, diseases, or symptoms, or (c) removing disorders, diseases, or symptoms. The therapeutic composition found through the method of the present invention serves to inhibit development of PCD diseases, more particularly, symptoms which have been caused by amyloid fibril formation by specifically binding to the Aβ oligomer in objects catching Alzheimer's disease, or remove or reduce the PCD diseases. Accordingly, the composition found by the method of the present invention may be a therapeutic composition of PCD itself or administrated together with other pharmacological ingredients to be applied as a therapeutic adjuvant for the diseases. Accordingly, in this specification, the term of treating or therapeutic agent include auxiliary treating or therapeutic aids.

In this specification, the term “prevention” means that it has been not diagnosed that the diseases or the disorders are preserved, but generation of the diseases or the disorders is suppressed in objects which are susceptible to the diseases or the disorders.

In this specification, the term “administration” or “administrating” means that the same amount is formed in the body of the object by directly administrating a therapeutically effective dose of the composition of the present invention to the object. The “therapeutically effective dose” of the composition means the content of extract which is sufficient to provide treating or preventing effects to the object to administrate the composition and including a prevented effective dose. In this specification, the term “object” includes human, mouse, rat, guinea pig, dog, cat, horse, cow, pig, monkey, chimpanzee, baboon or rhesus monkeys, without limitation. In detail, the object of the present invention is the human.

According to the detailed exemplary embodiment of the present invention, steps (a) and (b) of the present invention are performed by using computational simulation.

In this specification, the term “computational simulation” means a simulation which predicts and reproduces a behavior of a specific system through a mathematical modeling by using one or a plurality of computational equipment consisting of a network. More particularly, the computational simulation is a molecular dynamic simulation. The molecular dynamic simulation is a computational simulation that numerically calculates the trajectory of atoms or molecules according to established physical laws and reproduces physical movement thereof. According to the present invention, the inventors examined stereoscopic features to perform Aβ oligomer-specific detection by performing quantum computation with respect to BD-Oligo which is a compound found through high throughput screening (HTS), and performing molecular docking searching and molecular dynamic simulation of the BD-Oligo and Aβ oligomer complex. When the binding of the peptide of the present invention and the test material to which the features are reflected is analyzed through the molecular dynamic simulation, active therapeutic agent or diagnostic agent candidates other than the BD-Oligo can be derived.

According to the exemplary embodiment of the present invention, X₁ in Formula 1 is ALA.

According to the exemplary embodiment of the present invention, X₃, X₄, X₅, X₆, X₇ and X₈ in Formula 1 are independently selected from the group consisting of LEU, VAL, PHE, ALA, GLU, and ASP.

According to the exemplary embodiment of the present invention, X₃, X₄, X₅, X₆, X₇ and X₈ in Formula 1 are LEU, VAL, PHE, ALA, GLU, and ASP, respectively.

According to the exemplary embodiment of the present invention, X₉, X₁₀, X₁₁, X₁₂, X₁₃ and X₁₄ in Formula 1 are independently selected from the group consisting of ALA, ILE, and LEU.

According to the exemplary embodiment of the present invention, X₉, X₁₀, X₁₁, X₁₂, X₁₃ and X₁₄ in Formula 1 are ALA, ILE, ILE, ALA, LEU and ALA, respectively.

According to the exemplary embodiment of the present invention, n in Formula 1 is 2.

According to the exemplary embodiment of the present invention, m in Formula 1 is 3 or 12 and more particularly, m in Formula 1 is 3.

According to the exemplary embodiment of the present invention, PHE and C-terminal VAL between X₄ and X₅ in the Formula 1 has substantially the same coordinate as atom coordinate listed in Table 1 in the entire molecules.

In this specification, the term “substantially the same” means a sufficiently spatially similar case in at least a part of detailed 3D conformation of an atom coordinate (for example, things listed in Table 1) of a specific set. According to the present invention, an aromatic ring of the BD-Oligo which is the compound found through the HTS and a F19/V36 residue which is an exposed hydrophobic part in the Aβ oligomer form stacking interaction, and a carbonyl group of the BD-Oligo is bound to the Aβ oligomer by forming a CH—O bond with a V36 branched chain. Accordingly, peptide including six residues having substantially the same coordinate as a spatial coordinate of F19 and V36 in Aβ trimer listed in Table 1 provides information on whether the candidate materials are specifically bound to the Aβ oligomer. More particularly, substantially the same coordinate includes all values within a range of upper and lower limits of 0.05 of each coordinate listed in Table 1 and the like.

According to the exemplary embodiment of the present invention, the peptide used in the present invention has substantially the same coordinate as atomic coordinate listed in Table 2.

According to the present invention, the inventors used peptide mimicking a Aβ oligomer structure by binding 17-23 and 30-36 residue parts including F19 and V36, respectively, which are exposed hydrophobic residues which play an important role in the binding of the BD-Oligo as an exemplary binding material in the Aβ monomer with a modified linker. Accordingly, the peptide of the present invention has 54 residues corresponding trimer consisting of a monomer having 18 residues and an exemplary amino sequence of each monomer is AALVFFAEDAAAIIALAV (SEQ ID NO: 1) (Table 2). Among them, the residue corresponding to F19 of a natural Aβ monomer is No. 5 F and the residue corresponding to V36 is No. 18 V.

According to the exemplary embodiment of the present invention, the protein conformational disease to be prevented or treated by the composition screened by the method of the present invention is selected from the group consisting of Alzheimer's disease, Lewy body dementia, inclusion body myositis, and cerebral amyloid angiopathy and most particularly, Alzheimer's disease.

Another aspect of the present invention provides a screening method of a composition for diagnosing protein conformational diseases comprising the following steps:

(a) contacting peptide represented by the following Formula 1 and a test material to be analyzed;

[(X₁)ₙ-X₃-X₄-Phe-X₅-X₆-X₇-X₈-(X₂)ₙ-X₉-X₁₀-X₁₁-X₁₂-X₁₃-X₁₄-Val]ₘ Formula 1

in Formula 1, X₁ and X₂ are independently selected from the group consisting of ALA, GLY, and SER, respectively, X₃ to X₁₄ are independently selected from the group consisting of ALA, GLU, ILE, VAL, ASP, and LEU, respectively, and n is an integer of 2 to 4, and m is an integer of 3 to 12; and

(b) measuring binding of the peptide and the test material to be analyzed, in which when the binding of the peptide and the test material to be analyzed is detected, the test material is determined as the composition for diagnosing the protein conformational diseases.

Since the contacting of the peptide used in the present invention and the test material and the measuring of the binding to the test material are described above, in order to avoid excessive duplication, the disclosure thereof will be omitted.

In this specification, the term of diagnosis includes determining susceptibility of one object for a specific disease or disorder, determining whether one object has the specific disease or disorder at present, determining prognosis of one object having the specific disease or disorder, or therametrics (for example, monitoring an object state in order to provide information on the therapeutic efficacy). According to the present invention, based on the binding of the material found by the screening method of the present invention and the Aβ oligomer, when the fact that the binding degree thereof is significantly higher than the normal person is verified according various methods known in the art, it is determined that the level of the Aβ oligomer is increased and the risk of the protein conformational disease is high. In this specification, the term of increase in the risk of the protein conformational disease means that a possibility of the protein conformational disease is significantly high as compared with a normal object in a control group in the amount of Aβ oligomer.

The present invention will now be described in further detail by examples. It would be obvious to those skilled in the art that these examples are intended to be more concretely illustrative and the scope of the present invention as set forth in the appended claims is not limited to or by the examples.

### EXAMPLES

### Methods

### Diversity-Oriented Fluorescence Library (DOFL) High-Throughput/Content Screening.

DOFL compounds were diluted from 1 mM DMSO stock solutions with the culture medium to make a final concentration of 1 μM. Chinese Hamster Ovary (CHO) cells and 7PA2 cells, which were both kindly donated by Dr. Edward H. Koo(University of California, San Diego), were plated side by side in 384 well plates and incubated with DOFL compounds for 2 h at 37° C. 7PA2 cells were stably transfected with plasmid encoding APP751 with V717F mutation and reported to produce low MW Aβ oligomers (up to 4-mer) in intracellular vesicles prior to secretion into the cell culture medium. Detailed characterization of 7PA2 cells has been reported in the literature. The fluorescence cell images of two regions per well were acquired using an ImageXpress Microcellular imaging system(Molecular Device, Sunnyvale, Calif.) with 10× objective lens, and the intensity was analyzed by MetaXpress image processing software (Molecular Devices, Sunnyvale, Calif.) and manual observation. The compounds which stained 7PA2 cells with brighter appearance than CHO cells were selected as candidates.

### Peptide Preparation.

Synthetic Aβ1-40 was purchased from American Peptide Co. (Sunnyvale, Calif.) in lyophilized form. Dry peptide was dissolved in 1,1,1,3,3,3-hexafluoro-2-isopropanol (HFIP) and incubated at 25° C. for 1 h to remove any preformed aggregates. It was aliquoted into small aliquots and dried using a speed-vac. The dry peptide was stored at −20° C. until required, where each aliquot was then dissolved in 5 M GuHCl 10 mM Tris.Cl pH 8 to 1 mM peptide solution. After sonication in a sonicating water bath for 15 min, the solution was diluted with phosphate-buffered saline (PBS), pH 7.4, and stored on ice until use. This freshly prepared sample is referred to as monomer. To form fibrils, 100 μM sample is incubated for 24 h at 37° C. with 5 s shaking at a 7 min interval. Preformed oligomers were prepared by Aβ1-40 peptide solubilized in borate-buffered saline (50 mM BBS/PBS) and reacted with 5 mM glutaraldehyde overnight at 37° C. to produce stable oligomers by controlled polymerization, as previously described. The solution was neutralized with Tris buffer and then dialyzed against deionized distilled water overnight and lyophilized. Prior to fluorescence assays, it is resolubilized in deionized distilled water and diluted in PBS. Western blot performed on the sample with anti-Aβ 4G8/6E10 as primary antibody revealed major band of about 80 kDa and higher without monomers. By electron microscopy, the sample makes spheres of 10-20 nm.

### Time-Dependent Fibril Formation.

For monitoring of fibril formation over time, 40 M peptide solution of Aβ1-40 was prepared as above and incubated at 37° C. with 5 s shaking at every 7 min interval. Fluorescence readings were taken at various time point intervals by mixing a 30 μL aliquot of peptide solution to 10 M dye. ThT signal was monitored at 480 nm by 444 nm excitation, whereas BD-Oligo was excited at 530 nm and its emission detected at 585 nm. Fluorescence was measured using a SpectraMax M2 spectrophotometer (Molecular Devices, Sunnyvale, Calif.). Aβ1-40 was also coincubated with dye to study any effects the dye may have on fibril formation.

### Dot Blot Analysis.

A 3 μL amount of 40 M Aβ1-40 sample was spotted onto nitrocellulose membrane (Bio-Rad) at selected time points. The membranes were blocked by 10% (w/v) fat-free milk in 50 mM Tris 150 mM NaCl, pH 7.4, and 0.05% (v/v) Tween-20 (TBST buffer) for 1 h at room temperature, followed by incubation with antioligomer polyclonal A11 antibody (1:1000 dilution; Invitrogen) or Aβ1-16 (6E10) monoclonal antibody (1:1000 dilution; Covance) in 5% (w/v) fat-free milk and TBST buffer overnight at 4° C. The membranes were washed 3 times in TBST before incubation with antirabbit or antimouse antibody (1:5000 dilution) in 5% (w/v) fatfree milk and TBST buffer at room temperature for 1 h.

### Pelleting Assay.

Aβ1-40 samples were incubated at 37° C. At selected time points, aliquots of 150 μL were removed and subjected to centrifugation at 100 000 rpm (TL-100 rotor, Beckman) for 20 min at 4° C. Under these centrifugation conditions, monomeric Aβ does not sediment significantly. The concentration of monomeric Aβ in the supernatant after centrifugation was monitored using fluorescence measurements based on the reaction of fluorescamine with primary amine groups. The supernatants (45 μL) were added to a microtiter plate along with 15 μL of 1 mg/mL fluorescamine in DMSO. Samples were incubated at room temperature for 5 min, and fluorescence intensities were measured using a SpectraMax M2 spectrophotometer (Molecular Devices, Sunnyvale, Calif.) with excitation and emission filters of 355 and 460 nm, respectively.

### Transmission Electron Microscopy.

At selected time points, Aβ1-40 sample incubated at 37° C. was removed and applied to freshly glow-discharged carbon-coated copper grids. The grids were then stained with several drops of 2% potassium phosphotungstate, pH 6.8, and examined using an FEI Tecnai 12 transmission electron microscope operating at 120 kV. Images were obtained using an Olympus SiS MegaViewIII charge-coupled device camera.

### Ex Vivo Imaging of Brains.

For ex vivo imaging, a stock solution of BD-Oligo was made at 10 mM in 100% DMSO.

Eighteen month old APP/PS 1 transgenic (Tg) AD model mice were given intraperitoneal (ip) injections with either 1.25 μL of BD-Oligo diluted in 500 μL of saline (n=2) or 500 μL of saline alone (n=2). APP/PS 1 Tg mice develop amyloid plaques from 4 months of age. Mice were anesthetized with an overdose of sodium pentobarbital and perfused 0.1 M PBS, pH 7.4. Brains were removed 24 h after the ip injection and fixed by immersion in periodate-lysine-paraformaldehyde for 24 h, cryo-protected in 30% sucrose for 3 days, and sectioned into 40 μm coronal sections using a cryostat. Brain sections from the BD-Oligoinjected mouse and the control APP/PS 1 mouse that received a saline alone injection were then stained for Aβ using fluorescent immunohistochemistry. Briefly, free floating sections were incubated with MOM blocking reagent (Vector) followed by an overnight incubation at 4° C. with anti-Aβ antibodies 4G8 and 6E10 diluted in MOM protein concentrate (Vector), as the present inventors previously published. Sections were then incubated with a 488 conjugated secondary antibody (Jackson Immunoresearch) for 2 h at room temperature, mounted onto slides, and cover slipped. Staining was visualized using a LMD6500 fluorescent microscope (Leica); 6E10/4G8 staining was imaged using in the green (488) channel, and BD-Oligo was imaged in the red (561) channel.

### Computational Details.

The geometry of BD-Oligo was quantum mechanically optimized in the gas phase as well as in the aqueous phase. The stable complex structure of BD-Oligo with Aβ oligomer was executed by molecular docking search followed by allatom, explicit water molecular dynamics simulations. Thermodynamic analysis was then performed by applying the liquid integral-equation theory to simulated complex conformations.

### Reagents and Solvents

The chemicals, including aldehydes and solvents, were purchased from Sigma Aldrich, Fluka, MERCK, Acros and Alfa Aesar. All the chemicals were directly used without further purification. Normal phase column chromatography purification was carried out using MERCK silica Gel 60 (Particle size: 230-400 mesh, 0.040-0.063 mm).

### Measurements and Analysis

HPLC-MS was taken on an Agilent-1200 with a DAD detector and a single quadrupole mass spectrometer (6130 series). The analytical method, unless indicated, is A: H2O (0.1% HCOOH), B: CH3CN (0.1% HCOOH), gradient from 10 to 90% B in 10 minutes; C18 (2) Luna column (4.6×50 mm2, 3.5 m particle size). Spectroscopic and quantum yield data were measured on a SpectraMax M2 spectrophotometer (Molecular Devices). Compounds in solvent (100 μL) in 96-well polypropylene plates was for fluorescence measurement. Data analysis was performed using Graph Prism 5.0. 1H-NMR and 13C-NMR spectra were recorded on Bruker AMX500 (500 MHz) spectrometers, and chemical shifts are expressed in parts per million (ppm) and coupling constants are reported as a J value in Hertz (Hz).

### Quantum Yield Measurements

Quantum yields for BD-Oligo were measured by dividing the integrated emission area of their fluorescent spectrum against the area of Rhodamine B in EtOH excited at 490 nm (Φrho-B=0.7). Quantum yields were then calculated using equation (1), where F represents the integrated emission area of fluorescent spectrum, rI represents the refractive index of the solvent, and Abs represents absorbance at excitation wavelength selected for standards and samples. Emission was integrated from 530 nm to 750 nm.

$${Φ}_{flu}^{sample} = {Φ}_{flu}^{reference} ( \frac{{F}^{sample}}{{F}^{reference}} ) ( \frac{{η}^{sample}}{{η}^{reference}} ) ( \frac{{Abs}^{reference}}{{Abs}^{sample}} ) \qquad ( 1 )$$

### CD Spectroscopy

CD measurements were made using an Aviv model 62 DS CD spectrometer (Aviv Associates Inc., Lakewood, N.J.) at 25° C. with a 1-mm path length quartz cuvette, a spectral bandwidth of 1 nm, a signal averaging time of 1 s, and a data interval of 0.5 nm. The spectra presented are the averages of five measurements and corrected using a reference solution lacking Aβ.

### Computational Methods

### Quantum Mechanical Calculations

The geometry optimization for BD-Oligo compound was performed by using density functional theory at the B3LYP/6-31G* level at the gas phase as well as an aqueous phase using Gaussian 09 program. Vibrational frequency analyses were executed to verify the identity of each stationary point as an energy minimum.

### Molecular Docking Search and Molecular Dynamics (MD) Simulations

BD-Oligo docking search with Aβ oligomer were executed by using AutoDock 4.0 software package. The docking simulations were carried out with a box centered on the Aβ oligomer and employing 50×50×50 grid points. For the Aβ oligomer structure, we used X-ray (4NTR) determined Aβ trimers derived from the β-amyloid peptide as a working model for toxic Aβ oligomer associated with Alzheimer's disease. We used the Lennard-Jones (LJ) parameter of carbon for boron atom due to the absent of LJ parameter for boron. This is not a harsh substitution since boron atom has four coordination number in BD-Oligo. Based on the global docking search, the most energy-minimized complex structure of BD-Oligo with Aβ oligomer was used as an initial structure for MD simulations. We performed all-atom, explicit-water MD simulations using AMBER 14 package with the ff99SB force field for the Aβcomplex and the TIP4P-Ew model10 for water. The 5,329 water molecules were added to the simulation box. The particle mesh Ewald (PME) method was applied for dealing long-range electrostatic interactions while 10 Å cutoff was used for the short-range non-bonded interactions. The system was initially subjected to 500 steps of steepest descent minimization followed by 500 steps of conjugate gradient minimization while the complex structure was constrained by 500 kcal/(mol*Å²) harmonic potential. Then, the system was minimized using 1,000 steps of steepest descent minimization followed by 1,500 steps of conjugate gradient minimization without harmonic restraints. The system was subsequently subjected to a 20 ps equilibration process in which the temperature was gradually raised from T=0 to 310 K with a constant volume. This was followed by a 200 ps constant-pressure (NPT) ensemble simulation at T=310 K and P=1 bar. We then carried out a 2 ns production run at T=310 K and P=1 bar.

### Thermodynamics Calculations

We used the three-dimensional reference interaction site model (3D-RISM) theory to compute the solvation free energy ΔGsolv of the BD-Oligo complex with Aβ oligomer structure. This theory provides the equilibrium water distribution function around a given protein structure, with which ΔGsolv can be computed by using the Kirkwood charging formula. The internal energy (Eu) was directly computed from the force field used for the simulations. By combining the internal energy and the solvation free energy, we obtain a binding free energy (f=Eu+Gsolv). To obtain a residue-specific contribution to the binding free energy, we used an exact decomposition method which provides the site-directed thermodynamic contributions to the free energy upon complexation. In Figure S8, each bar represents the free energy difference (Δf) for each residue obtained from the free energy of Aβ oligomer with BD-Oligo (fcomplex) relative to Aβ oligomer without BD-Oligo (fAβ oligomer).

### Synthesis and Characterization

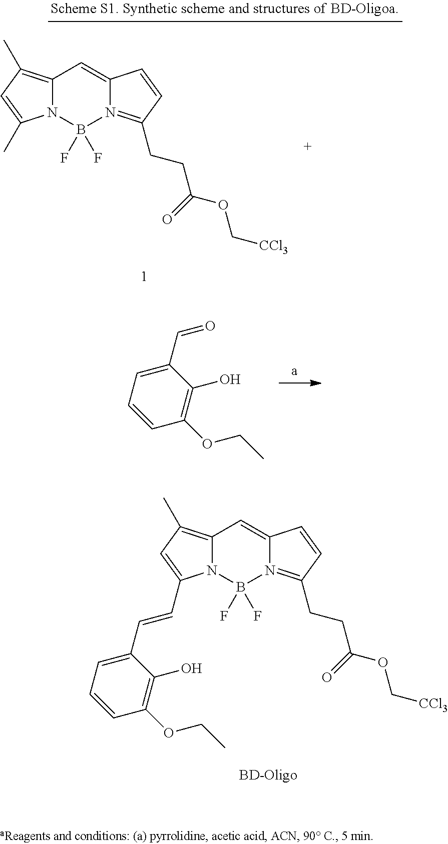

### Procedure for BD-Oligo Synthesis

Compound 1 (20 mg, 47 μmol) and aldehyde (94 μmol, 2 equiv) were dissolved in acetonitrile (3 mL), with 6 equiv. of pyrrolidine (23.5 μL, 282 μmol) and 6 equiv. of AcOH (16.1 μL, 282 μmol). The condensation reaction was performed by heating to 90° C. for 5 min. The reaction mixture was cooled down to room and concentrated under vacuum, and purified by short silica column (EtOAc/Hexane=2:3). Yield: 17.1 mg (63.8%).

### Results

### Oligomer-Specific Sensor Discovery (BD-Oligo) and Characterization.

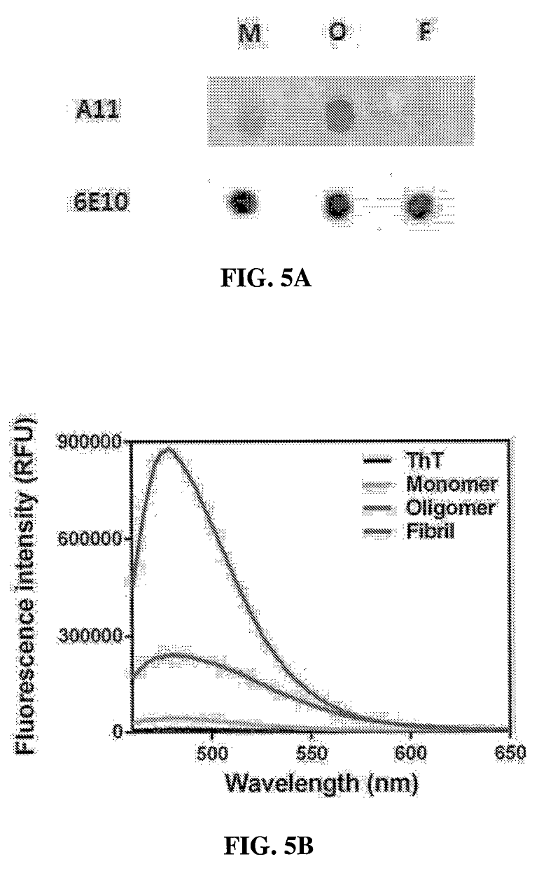

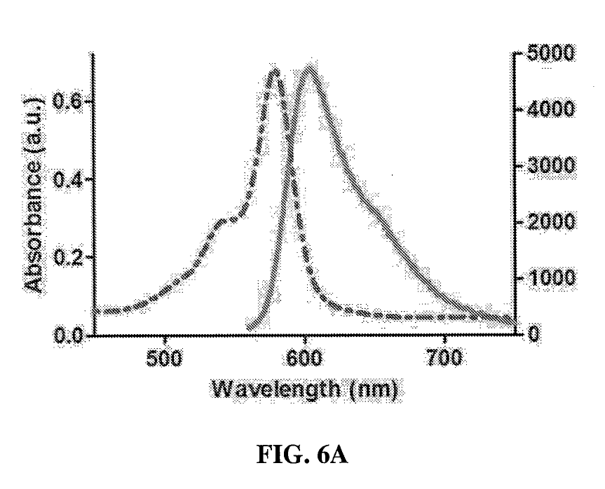

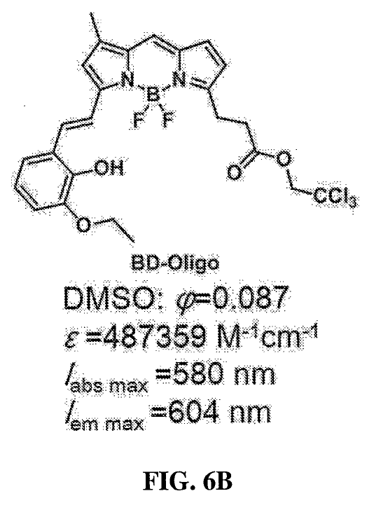

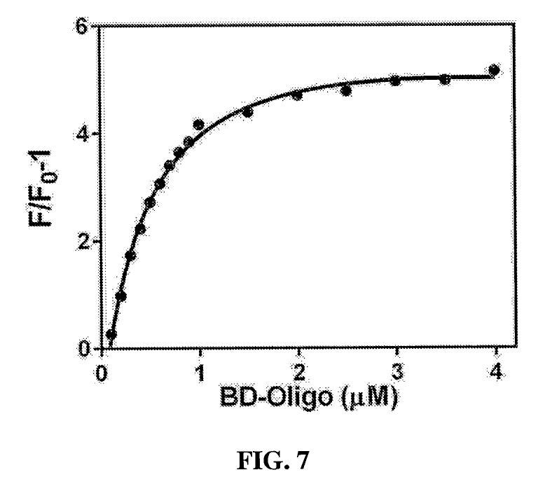

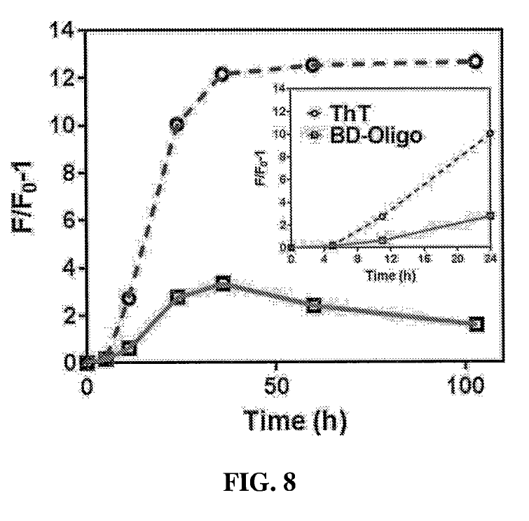

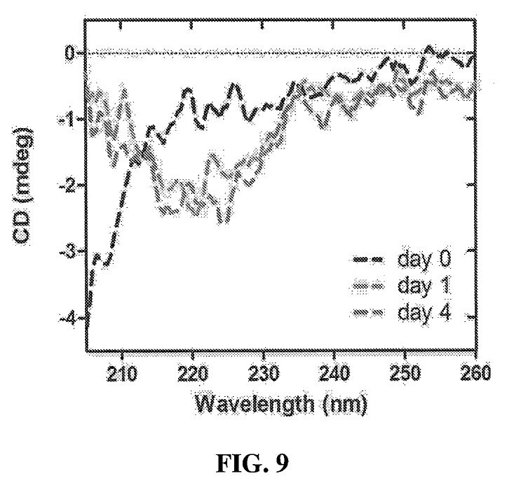

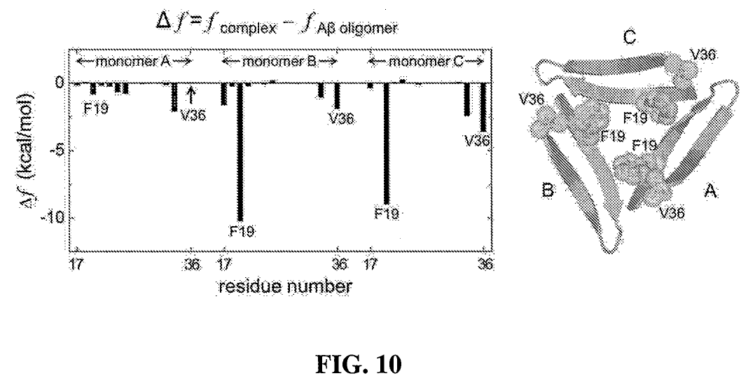

Since the proposed role of Aβ oligomers in the pathophysiology of AD, synthetic Aβ oligomers have been used as tools for the development of therapeutics and biomarkers. To develop an Aβ oligomer-selective probe in a living system, we incubated 7PA2 cells, which were reported to be enriched in Aβ oligomers, with 3500 DOFL compounds. When in the absence of mechanistic cues to rationally design probes for Aβ oligomers, we envisioned highthroughput screening to be crucial in helping us identify promising leads. By expanding this strategy, 5 candidate compounds were selected based on their higher fluorescence intensity in 7PA2 cells than in CHO cells, from which the 7PA2 cells were propagated. We then sought to further narrow these candidates by a more direct approach using a synthetically stabilized oligomer of Aβ in comparison to monomer and fibrils. While Aβ monomers and fibrils have been used widely, Aβ oligomer is challenging to form or maintain due to its dynamic nature. In this study, Aβ1-40 peptide was solubilized in borate-buffered saline (50 mM BBS/PBS) and reacted with 5 mM glutaraldehyde overnight at 37° C. to produce covalently stabilized Aβ oligomers, as previously described. The most selective oligomer fluorescence turn-on probe was dubbed BoDipy-Oligomer or BD-Oligo for short. With BD-Oligo, the highest fluorescence enhancement is observed upon incubation with Aβ oligomers, indicating a preference for these intermediary conformations of Aβ aggregation over monomers or fibrils (FIG. 5A).

We confirmed the conformations of different Aβ peptide preparation by dot blot assays, and the results showed that the oligomer responded most strongly to the antioligomer antibody(A11), which has been reported to specifically recognize a generic epitope common to prefibrillar oligomers but not monomers or fibrils. By blotting a replicate membrane with anti-Aβ1-16 (6E10) antibody, which does not discriminate different conformations of Aβ, a similar amount of protein was shown in all 3 Aβ preparations. Amyloid fibrils probe ThT showed fluorescence response in the increasing order of freshly prepared Aβ monomers, followed by oligomer and fibrils as expected (FIG. 5B).

The photophysical properties of BD-Oligo are characterized and summarized in Figure S2. To quantify the affinity of BDOligo for Aβ oligomers, we measured the apparent binding constant (Kd) of BD-Oligo by conducting a saturation assay. Transformation of the saturation binding data to a Scatchard plot indicated the affinity of BD-Oligo for oligomers with a Kd value of 0.48 μM (Figure S3).

### Characterization of BD-Oligo

¹H NMR (500 MHz, CDCl₃) 6=7.70 (s, 2H), 7.28 (dd, J=7.6 Hz, 1.0, 1H), 7.02 (s, 1H), 6.82 (m, 4H), 6.28 (d, J=3.9 Hz, 1H), 4.78 (s, 2H), 4.20-4.04 (m, 2H), 3.39 (t, J=7.5 Hz, 2H), 2.96 (t, J=7.5 Hz, 2H), 2.25 (s, 3H), 1.45 (t, J=7.0 Hz, 3H); 13C NMR (126 MHz, CDCl₃): 171.05, 157.99, 155.12, 145.96, 144.73, 143.09, 136.88, 133.60, 133.52, 126.81, 122.40, 121.88, 119.73, 119.43, 118.84, 116.97, 116.29, 112.13, 94.89, 74.02, 64.72, 33.03, 23.68, 14.81, 11.30. HRMS m/z (C₂₅H₂₄BCl₃F₂N₂O₄) calculated: 570.0863. found: 593.0775 (M+Na)⁺.

### BD-Oligo Detects Oligomers on Fibril Formation Pathway.

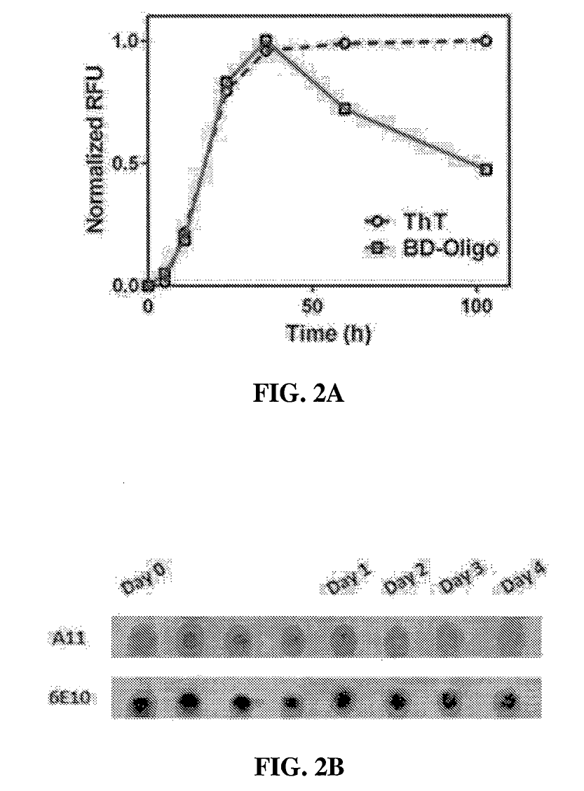

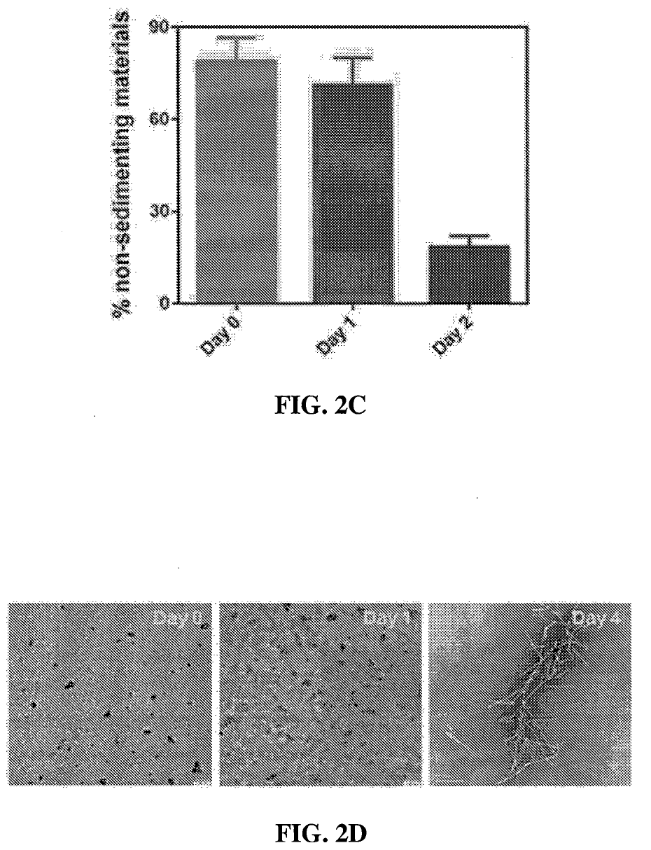

Next, we investigated the oligomer-sensing ability of BD-Oligo over the course of Aβ fibril formation using the same peptide preparation instead of 3 different preprepared conformations as described earlier. To do this we subjected Aβ peptide to fibril-forming conditions, and at each selected time point, a small aliquot was sampled and added to BD-Oligo for fluorescence measurement. Concurrently, Aβ fibril formation samples were monitored with ThT, which reaches a maximum fluorescence after about 1 day and plateaus for the remaining incubation period. Measurements with BD-Oligo observed a gradual increase in fluorescence, which reaches the maximum fluorescence intensity at about day 1 incubation, followed by a decrease in signal over the remaining incubation period (FIG. 2A, FIG. 8). Fluorescence measurement of BD-Oligo alone in the same manner reveals no change in its signal intensity (data not shown). We postulate that the observed change in fluorescence signal is an indication of BD-Oligo detecting Aβ oligomeric species on-fibril pathway, whereby the signal increases as monomers aggregate into oligomers but decreases as more Aβ assemble into fibrils. To elucidate the aggregated species or the changes in protein conformations that BD-Oligo may be recognizing, we performed biophysical characterization of the sample during Aβ fibril formation. Particular attention was paid toward the day 1 species, where the probe has been observed to yield maximum fluorescence enhancement. Dot blots over the course of fibril formation showed that A11 recognizes earlier species in the incubation, most intense at 3-5 h, as compared to BDOligo, which recognizes the later (day 1) species (FIG. 2B). Pelleting assay showed that at day 1, quite similar to day 0, the majority of Aβ are still in solution and have not aggregated into large sedimenting materials. This implies that the aggregated species which enhanced the fluorescence of BD-Oligo are soluble, which is in stark contrast to the decrease in the fraction of soluble protein after 2 days incubation (FIG. 2C). At the same time, transmission electron microscopic (TEM) images taken at the end of the 4 day incubation confirmed the presence of Aβ fibrils. In contrast, TEM images captured either immediately after fibril formation has been initiated (day 0) or after 1 day incubation did not yet show any signs of fibrils (FIG. 2D). The secondary structure of Aβ analyzed by circular dichroism (CD) spectroscopy at selected time points indicated that Aβ is a random coil when freshly initiated to form fibrils (day 0), consistent with reports in the literature, while day 1 species is observed to possess β-sheet content, similar to fibrils formed at day 4 (FIG. 9). Taken together, the presence of β-sheet structure alone does not suffice to explain the binding specificity of our probe.

Structural Characteristics of Aft Oligomer Complex with BD-Oligo.

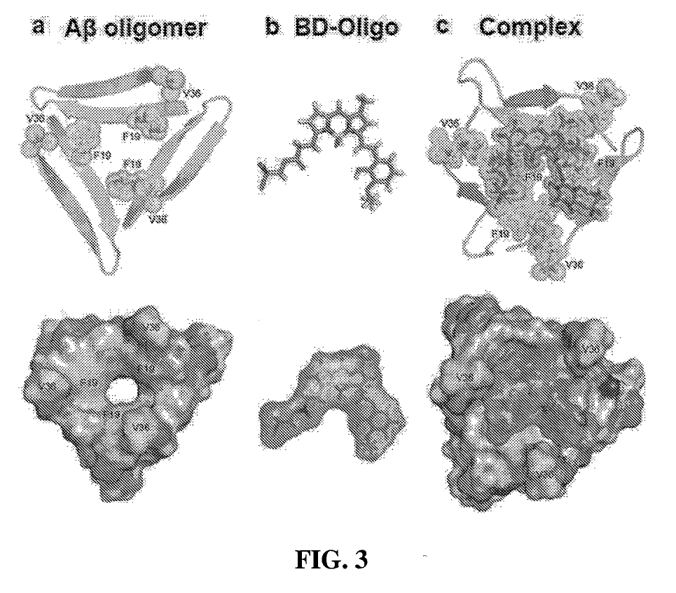

To understand the structural features and the binding specificity of BD-Oligo for Aβ oligomer over Aβ monomer and fibrils, we performed quantum mechanical calculations for BD-Oligo followed by a molecular docking search and molecular dynamics (MD) simulations for the complex of BD-Oligo and Aβ oligomer. To construct Aβ oligomer structure, we used X-ray-determined Aβ trimers derived from the β-amyloid peptide as a working model for toxic Aβ oligomer associated with neurodegeneration in AD(FIG. 3a). Though not a true depiction of the structure, the described computation methods offer a possible approximation as a starting point. BD-Oligo is most stable as a planar form in the gas phase as well as in an aqueous environment based on quantum mechanical calculations at the B3LYP/6-31G* level (FIG. 3b). To search for the stable complex structure of BDOligo with Aβ oligomer, we performed a molecular docking search followed by all-atom, explicit water MD simulations.

Upon complexation, BD-Oligo adopts a conformational transition from planar to twisted geometry in order to maximize the interaction with Aβ oligomer (FIG. 3c). The main binding mode is π-π stacking interactions between the aromatic rings of BD-Oligo and the exposed hydrophobic patches of Aβ oligomer. More specifically, the BODIPY ring and the phenyl ring of BD-Oligo are recognized by hydrophobic F19/V36 residues in A13 oligomer. Moreover, the carbonyl group of BD-Oligo forms CH—O bonding with V36 side chain. These binding modes between BD-Oligo and F19/V36 residues of Aβ oligomer are oligomer specific, since F19/V36 residues are exposed to solvent only in Aβ oligomer but not in Aβ fibrils. In addition, the F19/V36 residues are also less exposed to solvents in Aβ monomer, which displays intrinsic disorder in aqueous environments. The exposed F19/V36 residues which are only present in Aβ oligomer and not (or much less) in Aβ fibril (Aβ monomer) are quite suitable for BD-Oligo recognition by executing π-π stacking interactions as well as H bonding between them. This structural analysis offers the molecular motif on why BD-Oligo is an Aβ oligomer-specific detector. Atomic coordinates of the Aβ oligomer(4TNR) are shown in Table 1 and Table 2.

TABLE 1
Atomic coordinates of 19/V36 residue in the Aβ oligomer (4TNR)

| amino acid¹⁾ | atomin#²⁾ | atom | X axis | Y axis | Z axis | | |
|---|---|---|---|---|---|---|---|
| (m = 1)PHE | 1 | N | −6.421 | −2.621 | 0.015 | 0.00 | 0.00 |
| (m = 1)PHE | 2 | CA | −5.012 | −2.399 | −0.318 | 0.00 | 0.00 |
| (m = 1)PHE | 3 | C | −4.453 | −3.567 | −1.149 | 0.00 | 0.00 |
| (m = 1)PHE | 4 | O | −5.031 | −4.654 | −1.190 | 0.00 | 0.00 |
| (m = 1)PHE | 5 | CB | −4.203 | −2.220 | 0.977 | 0.00 | 0.00 |
| (m = 1)PHE | 6 | CG | −4.576 | −1.013 | 1.821 | 0.00 | 0.00 |
| (m = 1)PHE | 7 | CD1 | −5.529 | −1.130 | 2.850 | 0.00 | 0.00 |
| (m = 1)PHE | 8 | CD2 | −3.933 | 0.223 | 1.607 | 0.00 | 0.00 |
| (m = 1)PHE | 9 | CE1 | −5.827 | −0.024 | 3.666 | 0.00 | 0.00 |
| (m = 1)PHE | 10 | CE2 | −4.227 | 1.326 | 2.426 | 0.00 | 0.00 |
| (m = 1)PHE | 11 | CZ | −5.175 | 1.203 | 3.458 | 0.00 | 0.00 |
| (m = 1)PHE | 12 | H | −6.642 | −3.503 | 0.464 | 0.00 | 0.00 |
| (m = 1)PHE | 13 | HA | −4.916 | −1.491 | −0.914 | 0.00 | 0.00 |
| (m = 1)PHE | 14 | HB2 | −4.312 | −3.119 | 1.586 | 0.00 | 0.00 |
| (m = 1)PHE | 15 | HB3 | −3.145 | −2.136 | 0.723 | 0.00 | 0.00 |
| (m = 1)PHE | 16 | HD1 | −6.031 | −2.072 | 3.022 | 0.00 | 0.00 |
| (m = 1)PHE | 17 | HD2 | −3.204 | 0.328 | 0.815 | 0.00 | 0.00 |
| (m = 1)PHE | 18 | HE1 | −6.555 | −0.124 | 4.460 | 0.00 | 0.00 |
| (m = 1)PHE | 19 | HE2 | −3.722 | 2.268 | 2.260 | 0.00 | 0.00 |
| (m = 1)PHE | 20 | HZ | −5.398 | 2.051 | 4.088 | 0.00 | 0.00 |
| (m = 1)VAL | 1 | N | −8.230 | −3.726 | 5.411 | 0.00 | 0.00 |
| (m = 1)VAL | 2 | CA | −7.728 | −3.246 | 6.720 | 0.00 | 0.00 |
| (m = 1)VAL | 3 | C | −8.627 | −2.196 | 7.349 | 0.00 | 0.00 |
| (m = 1)VAL | 4 | O | −8.747 | −1.076 | 6.809 | 0.00 | 0.00 |
| (m = 1)VAL | 5 | CB | −6.263 | −2.757 | 6.616 | 0.00 | 0.00 |
| (m = 1)VAL | 6 | CG1 | −5.737 | −2.296 | 7.977 | 0.00 | 0.00 |
| (m = 1)VAL | 7 | CG2 | −5.347 | −3.890 | 6.117 | 0.00 | 0.00 |
| (m = 1)VAL | 8 | OXT | −9.198 | −2.496 | 8.421 | 0.00 | 0.00 |
| (m = 1)VAL | 9 | H | −8.395 | −3.024 | 4.699 | 0.00 | 0.00 |
| (m = 1)VAL | 10 | HA | −7.730 | −4.076 | 7.427 | 0.00 | 0.00 |
| (m = 1)VAL | 11 | HB | −6.209 | −1.930 | 5.916 | 0.00 | 0.00 |
| (m = 1)VAL | 12 | 1HG1 | −5.853 | −3.089 | 8.715 | 0.00 | 0.00 |
| (m = 1)VAL | 13 | 2HG1 | −4.680 | −2.034 | 7.900 | 0.00 | 0.00 |
| (m = 1)VAL | 14 | 3HG1 | −6.280 | −1.411 | 8.312 | 0.00 | 0.00 |
| (m = 1)VAL | 15 | 1HG2 | −5.605 | −4.162 | 5.098 | 0.00 | 0.00 |
| (m = 1)VAL | 16 | 2HG2 | −4.310 | −3.559 | 6.126 | 0.00 | 0.00 |
| (m = 1)VAL | 17 | 3HG2 | −5.446 | −4.763 | 6.761 | 0.00 | 0.00 |
| (m = 2)PHE | 1 | N | 0.507 | 7.190 | −0.051 | 0.00 | 0.00 |
| (m = 2)PHE | 2 | CA | −0.062 | 5.941 | −0.266 | 0.00 | 0.00 |
| (m = 2)PHE | 3 | C | −1.426 | 5.941 | −0.975 | 0.00 | 0.00 |
| (m = 2)PHE | 4 | O | −2.013 | 7.019 | −1.071 | 0.00 | 0.00 |
| (m = 2)PHE | 5 | CB | −0.170 | 5.134 | 1.091 | 0.00 | 0.00 |
| (m = 2)PHE | 6 | CG | 1.157 | 4.906 | 1.796 | 0.00 | 0.00 |
| (m = 2)PHE | 7 | CD1 | 1.807 | 3.661 | 1.693 | 0.00 | 0.00 |
| (m = 2)PHE | 8 | CD2 | 1.747 | 5.937 | 2.554 | 0.00 | 0.00 |
| (m = 2)PHE | 9 | CE1 | 3.035 | 3.450 | 2.344 | 0.00 | 0.00 |
| (m = 2)PHE | 10 | CE2 | 2.991 | 5.736 | 3.177 | 0.00 | 0.00 |
| (m = 2)PHE | 11 | CZ | 3.635 | 4.490 | 3.073 | 0.00 | 0.00 |
| (m = 2)PHE | 12 | H | −0.096 | 7.868 | 0.402 | 0.00 | 0.00 |
| (m = 2)PHE | 13 | HA | 0.603 | 5.272 | −0.907 | 0.00 | 0.00 |
| (m = 2)PHE | 14 | HB2 | −0.814 | 5.715 | 1.750 | 0.00 | 0.00 |
| (m = 2)PHE | 15 | HB3 | −0.651 | 4.166 | 0.942 | 0.00 | 0.00 |
| (m = 2)PHE | 16 | HD1 | 1.368 | 2.862 | 1.113 | 0.00 | 0.00 |
| (m = 2)PHE | 17 | HD2 | 1.253 | 6.894 | 2.645 | 0.00 | 0.00 |
| (m = 2)PHE | 18 | HE1 | 3.521 | 2.487 | 2.270 | 0.00 | 0.00 |
| (m = 2)PHE | 19 | HE2 | 3.440 | 6.537 | 3.744 | 0.00 | 0.00 |
| (m = 2)PHE | 20 | HZ | 4.584 | 4.325 | 3.565 | 0.00 | 0.00 |
| (m = 2)VAL | 1 | N | 0.692 | 11.186 | 4.953 | 0.00 | 0.00 |
| (m = 2)VAL | 2 | CA | 1.184 | 11.172 | 6.348 | 0.00 | 0.00 |
| (m = 2)VAL | 3 | C | 1.637 | 12.542 | 6.835 | 0.00 | 0.00 |
| (m = 2)VAL | 4 | O | 2.490 | 13.172 | 6.167 | 0.00 | 0.00 |
| (m = 2)VAL | 5 | CB | 2.289 | 10.114 | 6.523 | 0.00 | 0.00 |
| (m = 2)VAL | 6 | CG1 | 2.761 | 10.034 | 7.980 | 0.00 | 0.00 |
| (m = 2)VAL | 7 | CG2 | 1.793 | 8.721 | 6.110 | 0.00 | 0.00 |
| (m = 2)VAL | 8 | OXT | 1.145 | 12.970 | 7.898 | 0.00 | 0.00 |
| (m = 2)VAL | 9 | H | 1.308 | 10.816 | 4.241 | 0.00 | 0.00 |
| (m = 2)VAL | 10 | HA | 0.361 | 10.886 | 6.999 | 0.00 | 0.00 |
| (m = 2)VAL | 11 | HB | 3.138 | 10.379 | 5.892 | 0.00 | 0.00 |
| (m = 2)VAL | 12 | 1HG1 | 1.915 | 9.832 | 8.636 | 0.00 | 0.00 |
| (m = 2)VAL | 13 | 2HG1 | 3.499 | 9.240 | 8.091 | 0.00 | 0.00 |
| (m = 2)VAL | 14 | 3HG1 | 3.227 | 10.973 | 8.280 | 0.00 | 0.00 |
| (m = 2)VAL | 15 | 1HG2 | 1.563 | 8.698 | 5.044 | 0.00 | 0.00 |
| (m = 2)VAL | 16 | 2HG2 | 2.568 | 7.978 | 6.298 | 0.00 | 0.00 |
| (m = 2)VAL | 17 | 3HG2 | 0.899 | 8.457 | 6.675 | 0.00 | 0.00 |
| (m = 3)PHE | 1 | N | 5.068 | −4.112 | 0.230 | 0.00 | 0.00 |
| (m = 3)PHE | 2 | CA | 4.165 | −2.989 | −0.030 | 0.00 | 0.00 |
| (m = 3)PHE | 3 | C | 4.879 | −1.894 | −0.836 | 0.00 | 0.00 |
| (m = 3)PHE | 4 | O | 6.103 | −1.917 | −0.963 | 0.00 | 0.00 |
| (m = 3)PHE | 5 | CB | 3.642 | −2.444 | 1.309 | 0.00 | 0.00 |
| (m = 3)PHE | 6 | CG | 3.180 | −3.504 | 2.295 | 0.00 | 0.00 |
| (m = 3)PHE | 7 | CD1 | 1.993 | −4.225 | 2.059 | 0.00 | 0.00 |
| (m = 3)PHE | 8 | CD2 | 3.948 | −3.778 | 3.444 | 0.00 | 0.00 |
| (m = 3)PHE | 9 | CE1 | 1.569 | −5.201 | 2.978 | 0.00 | 0.00 |
| (m = 3)PHE | 10 | CE2 | 3.518 | −4.747 | 4.366 | 0.00 | 0.00 |
| (m = 3)PHE | 11 | CZ | 2.324 | −5.451 | 4.138 | 0.00 | 0.00 |
| (m = 3)PHE | 12 | H | 2.324 | −3.914 | 0.807 | 0.00 | 0.00 |
| (m = 3)PHE | 13 | HA | 3.312 | −3.336 | −0.615 | 0.00 | 0.00 |
| (m = 3)PHE | 14 | HB2 | 4.435 | −1.858 | 1.776 | 0.00 | 0.00 |
| (m = 3)PHE | 15 | HB3 | 2.811 | −1.764 | 1.114 | 0.00 | 0.00 |
| (m = 3)PHE | 16 | HD1 | 1.402 | −4.022 | 1.176 | 0.00 | 0.00 |
| (m = 3)PHE | 17 | HD2 | 4.866 | −3.237 | 3.626 | 0.00 | 0.00 |
| (m = 3)PHE | 18 | HE1 | 0.645 | −5.737 | 2.812 | 0.00 | 0.00 |
| (m = 3)PHE | 19 | HE2 | 4.095 | −4.936 | 5.260 | 0.00 | 0.00 |
| (m = 3)PHE | 20 | HZ | 1.976 | −6.171 | 4.864 | 0.00 | 0.00 |
| (m = 3)VAL | 1 | N | 8.155 | −6.031 | 5.671 | 0.00 | 0.00 |
| (m = 3)VAL | 2 | CA | 7.906 | −6.371 | 7.087 | 0.00 | 0.00 |
| (m = 3)VAL | 3 | C | 9.204 | −6.528 | 7.876 | 0.00 | 0.00 |
| (m = 3)VAL | 4 | O | 10.204 | −7.008 | 7.307 | 0.00 | 0.00 |
| (m = 3)VAL | 5 | CB | 7.008 | −7.620 | 7.179 | 0.00 | 0.00 |
| (m = 3)VAL | 6 | CG1 | 6.714 | −8.039 | 8.624 | 0.00 | 0.00 |
| (m = 3)VAL | 7 | CG2 | 5.654 | −7.363 | 6.500 | 0.00 | 0.00 |
| (m = 3)VAL | 8 | OXT | 9.212 | −6.124 | 9.064 | 0.00 | 0.00 |
| (m = 3)VAL | 9 | H | 7.796 | −6.668 | 4.978 | 0.00 | 0.00 |
| (m = 3)VAL | 10 | HA | 7.374 | −5.539 | 7.541 | 0.00 | 0.00 |
| (m = 3)VAL | 11 | HB | 7.504 | −8.449 | 6.674 | 0.00 | 0.00 |
| (m = 3)VAL | 12 | 1HG1 | 6.305 | −7.197 | 9.184 | 0.00 | 0.00 |
| (m = 3)VAL | 13 | 2HG1 | 6.001 | −8.863 | 8.641 | 0.00 | 0.00 |
| (m = 3)VAL | 14 | 3HG1 | 7.629 | −8.379 | 9.105 | 0.00 | 0.00 |
| (m = 3)VAL | 15 | 1HG2 | 5.787 | −7.145 | 5.442 | 0.00 | 0.00 |
| (m = 3)VAL | 16 | 2HG2 | 5.020 | −8.244 | 6.589 | 0.00 | 0.00 |
| (m = 3)VAL | 17 | 3HG2 | 5.156 | −6.518 | 6.977 | 0.00 | 0.00 |

TABLE 2
Atomic coordinates of 19/V36 residue in the Aβ oligomer (4TNR)

| atom- | | | | | | | | |
|---|---|---|---|---|---|---|---|---|
| ic | | | a.a. | | | | | |
| No. | Atom | A.A. | No | X axis | Y axis | Z axis | | |
| 1 | N | ALA | 1 | −15.001 | −3.720 | 3.884 | 0.00 | 0.00 |
| 2 | CA | ALA | 1 | −14.101 | −2.585 | 3.601 | 0.00 | 0.00 |
| 3 | C | ALA | 1 | −12.707 | −3.131 | 3.291 | 0.00 | 0.00 |
| 4 | O | ALA | 1 | −12.627 | −4.081 | 2.527 | 0.00 | 0.00 |
| 5 | CB | ALA | 1 | −14.645 | −1.747 | 2.433 | 0.00 | 0.00 |
| 6 | HA | ALA | 1 | −14.043 | −1.948 | 4.482 | 0.00 | 0.00 |
| 7 | HB1 | ALA | 1 | −13.959 | −0.931 | 2.205 | 0.00 | 0.00 |
| 8 | HB2 | ALA | 1 | −14.756 | −2.369 | 1.543 | 0.00 | 0.00 |
| 9 | HB3 | ALA | 1 | −15.614 | −1.323 | 2.700 | 0.00 | 0.00 |
| 10 | H1 | ALA | 1 | −14.634 | −4.288 | 4.634 | 0.00 | 0.00 |
| 11 | H2 | ALA | 1 | −15.066 | −4.302 | 3.056 | 0.00 | 0.00 |
| 12 | H3 | ALA | 1 | −15.926 | −3.389 | 4.119 | 0.00 | 0.00 |
| 13 | N | ALA | 2 | −11.602 | −2.643 | 3.862 | 0.00 | 0.00 |
| 14 | CA | ALA | 2 | −11.428 | −1.498 | 4.766 | 0.00 | 0.00 |
| 15 | C | ALA | 2 | −12.027 | −0.197 | 4.197 | 0.00 | 0.00 |
| 16 | O | ALA | 2 | −13.125 | 0.175 | 4.603 | 0.00 | 0.00 |
| 17 | CB | ALA | 2 | −11.916 | −1.875 | 6.176 | 0.00 | 0.00 |
| 18 | H | ALA | 2 | −10.738 | −3.053 | 3.531 | 0.00 | 0.00 |
| 19 | HA | ALA | 2 | −10.361 | −1.316 | 4.879 | 0.00 | 0.00 |
| 20 | HB1 | ALA | 2 | −12.993 | −2.026 | 6.204 | 0.00 | 0.00 |
| 21 | HB2 | ALA | 2 | −11.413 | −2.784 | 6.510 | 0.00 | 0.00 |
| 22 | HB3 | ALA | 2 | −11.659 | −1.072 | 6.869 | 0.00 | 0.00 |
| 23 | N | LEU | 3 | −11.445 | 0.504 | 3.215 | 0.00 | 0.00 |
| 24 | CA | LEU | 3 | −10.087 | 0.452 | 2.632 | 0.00 | 0.00 |
| 25 | C | LEU | 3 | −9.547 | −0.916 | 2.148 | 0.00 | 0.00 |
| 26 | O | LEU | 3 | −9.059 | −1.727 | 2.940 | 0.00 | 0.00 |
| 27 | CB | LEU | 3 | −9.078 | 1.148 | 3.572 | 0.00 | 0.00 |
| 28 | CG | LEU | 3 | −9.463 | 2.530 | 4.135 | 0.00 | 0.00 |
| 29 | CD1 | LEU | 3 | −8.275 | 3.119 | 4.894 | 0.00 | 0.00 |
| 30 | CD2 | LEU | 3 | −9.846 | 3.517 | 3.036 | 0.00 | 0.00 |
| 31 | H | LEU | 3 | −12.013 | 1.278 | 2.892 | 0.00 | 0.00 |
| 32 | HA | LEU | 3 | −10.129 | 1.070 | 1.734 | 0.00 | 0.00 |
| 33 | HB2 | LEU | 3 | −8.882 | 0.490 | 4.420 | 0.00 | 0.00 |
| 34 | HB3 | LEU | 3 | −8.147 | 1.258 | 3.015 | 0.00 | 0.00 |
| 35 | HG | LEU | 3 | −10.300 | 2.423 | 4.824 | 0.00 | 0.00 |
| 36 | 1HD1 | LEU | 3 | −7.443 | 3.292 | 4.213 | 0.00 | 0.00 |
| 37 | 2HD1 | LEU | 3 | −8.565 | 4.065 | 5.350 | 0.00 | 0.00 |
| 38 | 3HD1 | LEU | 3 | −7.967 | 2.431 | 5.679 | 0.00 | 0.00 |
| 39 | 1HD2 | LEU | 3 | −10.770 | 3.196 | 2.563 | 0.00 | 0.00 |
| 40 | 2HD2 | LEU | 3 | −10.013 | 4.505 | 3.467 | 0.00 | 0.00 |
| 41 | 3HD2 | LEU | 3 | −9.053 | 3.572 | 2.291 | 0.00 | 0.00 |
| 42 | N | VAL | 4 | −9.564 | −1.157 | 0.834 | 0.00 | 0.00 |
| 43 | CA | VAL | 4 | −8.824 | −2.273 | 0.214 | 0.00 | 0.00 |
| 44 | C | VAL | 4 | −7.439 | −1.805 | −0.251 | 0.00 | 0.00 |
| 45 | O | VAL | 4 | −7.296 | −0.736 | −0.845 | 0.00 | 0.00 |
| 46 | CB | VAL | 4 | −9.639 | −2.943 | −0.910 | 0.00 | 0.00 |
| 47 | CG1 | VAL | 4 | −8.848 | −4.032 | −1.647 | 0.00 | 0.00 |
| 48 | CG2 | VAL | 4 | −10.914 | −3.584 | −0.348 | 0.00 | 0.00 |
| 49 | H | VAL | 4 | −9.988 | −0.482 | 0.205 | 0.00 | 0.00 |
| 50 | HA | VAL | 4 | −8.659 | −3.043 | 0.966 | 0.00 | 0.00 |
| 51 | HB | VAL | 4 | −9.935 | −2.188 | −1.632 | 0.00 | 0.00 |
| 52 | 1HG1 | VAL | 4 | −8.498 | −4.787 | −0.943 | 0.00 | 0.00 |
| 53 | 2HG1 | VAL | 4 | −9.486 | −4.509 | −2.388 | 0.00 | 0.00 |
| 54 | 3HG1 | VAL | 4 | −7.997 | −3.599 | −2.171 | 0.00 | 0.00 |
| 55 | 1HG2 | VAL | 4 | −11.545 | −2.824 | 0.110 | 0.00 | 0.00 |
| 56 | 2HG2 | VAL | 4 | −11.477 | −4.051 | −1.157 | 0.00 | 0.00 |
| 57 | 3HG2 | VAL | 4 | −10.659 | −4.341 | 0.395 | 0.00 | 0.00 |
| 58 | N | PHE | 5 | −6.421 | −2.621 | 0.015 | 0.00 | 0.00 |
| 59 | CA | PHE | 5 | −5.012 | −2.399 | −0.318 | 0.00 | 0.00 |
| 60 | C | PHE | 5 | −4.453 | −3.567 | −1.149 | 0.00 | 0.00 |
| 61 | O | PHE | 5 | −5.031 | −4.654 | −1.190 | 0.00 | 0.00 |
| 62 | CB | PHE | 5 | −4.203 | −2.220 | 0.977 | 0.00 | 0.00 |
| 63 | CG | PHE | 5 | −4.576 | −1.013 | 1.821 | 0.00 | 0.00 |
| 64 | CD1 | PHE | 5 | −5.529 | −1.130 | 2.850 | 0.00 | 0.00 |
| 65 | CD2 | PHE | 5 | −3.933 | 0.223 | 1.607 | 0.00 | 0.00 |
| 66 | CE1 | PHE | 5 | −5.827 | −0.024 | 3.666 | 0.00 | 0.00 |
| 67 | CE2 | PHE | 5 | −4.227 | 1.326 | 2.426 | 0.00 | 0.00 |
| 68 | CZ | PHE | 5 | −5.175 | 1.203 | 3.458 | 0.00 | 0.00 |
| 69 | H | PHE | 5 | −6.642 | −3.503 | 0.464 | 0.00 | 0.00 |
| 70 | HA | PHE | 5 | −4.916 | −1.491 | −0.914 | 0.00 | 0.00 |
| 71 | HB2 | PHE | 5 | −4.312 | −3.119 | 1.586 | 0.00 | 0.00 |
| 72 | HB3 | PHE | 5 | −3.145 | −2.136 | 0.723 | 0.00 | 0.00 |
| 73 | HD1 | PHE | 5 | −6.031 | −2.072 | 3.022 | 0.00 | 0.00 |
| 74 | HD2 | PHE | 5 | −3.204 | 0.328 | 0.815 | 0.00 | 0.00 |
| 75 | HE1 | PHE | 5 | −6.555 | −0.124 | 4.460 | 0.00 | 0.00 |
| 76 | HE2 | PHE | 5 | −3.722 | 2.268 | 2.260 | 0.00 | 0.00 |
| 77 | HZ | PHE | 5 | −5.398 | 2.051 | 4.088 | 0.00 | 0.00 |
| 78 | N | PHE | 6 | −3.293 | −3.364 | −1.777 | 0.00 | 0.00 |
| 79 | CA | PHE | 6 | −2.591 | −4.370 | −2.585 | 0.00 | 0.00 |
| 80 | C | PHE | 6 | −1.207 | −4.681 | −2.002 | 0.00 | 0.00 |
| 81 | O | PHE | 6 | −0.555 | −3.790 | −1.454 | 0.00 | 0.00 |
| 82 | CB | PHE | 6 | −2.474 | −3.884 | −4.038 | 0.00 | 0.00 |
| 83 | CG | PHE | 6 | −3.792 | −3.481 | −4.672 | 0.00 | 0.00 |
| 84 | CD1 | PHE | 6 | −4.677 | −4.469 | −5.143 | 0.00 | 0.00 |
| 85 | CD2 | PHE | 6 | −4.149 | −2.120 | −4.765 | 0.00 | 0.00 |
| 86 | CE1 | PHE | 6 | −5.914 | −4.098 | −5.700 | 0.00 | 0.00 |
| 87 | CE2 | PHE | 6 | −5.387 | −1.750 | −5.317 | 0.00 | 0.00 |
| 88 | CZ | PHE | 6 | −6.271 | −2.740 | −5.780 | 0.00 | 0.00 |
| 89 | H | PHE | 6 | −2.827 | −2.480 | −1.650 | 0.00 | 0.00 |
| 90 | HA | PHE | 6 | −3.161 | −5.299 | −2.593 | 0.00 | 0.00 |
| 91 | HB2 | PHE | 6 | −1.792 | −3.033 | −4.070 | 0.00 | 0.00 |
| 92 | HB3 | PHE | 6 | −2.028 | −4.680 | −4.638 | 0.00 | 0.00 |
| 93 | HD1 | PHE | 6 | −4.414 | −5.515 | −5.065 | 0.00 | 0.00 |
| 94 | HD2 | PHE | 6 | −3.478 | −1.356 | −4.399 | 0.00 | 0.00 |
| 95 | HE1 | PHE | 6 | −6.601 | −4.854 | −6.059 | 0.00 | 0.00 |
| 96 | HE2 | PHE | 6 | −5.668 | −0.707 | −5.380 | 0.00 | 0.00 |
| 97 | HZ | PHE | 6 | −7.229 | −2.458 | −6.197 | 0.00 | 0.00 |
| 98 | N | ALA | 7 | −0.741 | −5.923 | −2.149 | 0.00 | 0.00 |
| 99 | CA | ALA | 7 | 0.599 | −6.336 | −1.735 | 0.00 | 0.00 |
| 100 | C | ALA | 7 | 1.227 | −7.333 | −2.722 | 0.00 | 0.00 |
| 101 | O | ALA | 7 | 0.547 | −8.161 | −3.336 | 0.00 | 0.00 |
| 102 | CB | ALA | 7 | 0.539 | −6.900 | −0.309 | 0.00 | 0.00 |
| 103 | H | ALA | 7 | −1.320 | −6.617 | −2.615 | 0.00 | 0.00 |
| 104 | HA | ALA | 7 | 1.247 | −5.457 | −1.713 | 0.00 | 0.00 |
| 105 | HB1 | ALA | 7 | −0.076 | −7.798 | −0.286 | 0.00 | 0.00 |
| 106 | HB2 | ALA | 7 | 1.546 | −7.146 | 0.030 | 0.00 | 0.00 |
| 107 | HB3 | ALA | 7 | 0.113 | −6.156 | 0.364 | 0.00 | 0.00 |
| 108 | N | GLU | 8 | 2.550 | −7.267 | −2.846 | 0.00 | 0.00 |
| 109 | CA | GLU | 8 | 3.345 | −8.270 | −3.544 | 0.00 | 0.00 |
| 110 | C | GLU | 8 | 3.732 | −9.389 | −2.564 | 0.00 | 0.00 |
| 111 | O | GLU | 8 | 4.285 | −9.140 | −1.494 | 0.00 | 0.00 |
| 112 | CB | GLU | 8 | 4.556 | −7.597 | −4.219 | 0.00 | 0.00 |
| 113 | CG | GLU | 8 | 5.378 | −8.566 | −5.079 | 0.00 | 0.00 |
| 114 | CD | GLU | 8 | 6.837 | −8.132 | −5.226 | 0.00 | 0.00 |
| 115 | OE1 | GLU | 8 | 7.755 | −8.867 | −4.784 | 0.00 | 0.00 |
| 116 | OE2 | GLU | 8 | 7.141 | −7.036 | −5.758 | 0.00 | 0.00 |
| 117 | H | GLU | 8 | 3.053 | −6.610 | −2.255 | 0.00 | 0.00 |
| 118 | HA | GLU | 8 | 2.736 | −8.708 | −4.335 | 0.00 | 0.00 |
| 119 | HB2 | GLU | 8 | 4.208 | −6.782 | −4.855 | 0.00 | 0.00 |
| 120 | HB3 | GLU | 8 | 5.192 | −7.174 | −3.444 | 0.00 | 0.00 |
| 121 | HG2 | GLU | 8 | 5.368 | −9.553 | −4.624 | 0.00 | 0.00 |
| 122 | HG3 | GLU | 8 | 4.921 | −8.649 | −6.065 | 0.00 | 0.00 |
| 123 | N | ASP | 9 | 3.470 | −10.636 | −2.950 | 0.00 | 0.00 |
| 124 | CA | ASP | 9 | 3.841 | −11.853 | −2.217 | 0.00 | 0.00 |
| 125 | C | ASP | 9 | 4.738 | −12.769 | −3.084 | 0.00 | 0.00 |
| 126 | O | ASP | 9 | 4.824 | −13.981 | −2.864 | 0.00 | 0.00 |
| 127 | CB | ASP | 9 | 2.545 | −12.541 | −1.744 | 0.00 | 0.00 |
| 128 | CG | ASP | 9 | 2.810 | −13.628 | −0.707 | 0.00 | 0.00 |
| 129 | OD1 | ASP | 9 | 3.588 | −13.364 | 0.238 | 0.00 | 0.00 |
| 130 | OD2 | ASP | 9 | 2.265 | −14.753 | −0.820 | 0.00 | 0.00 |
| 131 | H | ASP | 9 | 2.998 | −10.785 | −3.835 | 0.00 | 0.00 |
| 132 | HA | ASP | 9 | 4.423 | −11.578 | −1.338 | 0.00 | 0.00 |
| 133 | HB2 | ASP | 9 | 1.895 | −11.793 | −1.285 | 0.00 | 0.00 |
| 134 | HB3 | ASP | 9 | 2.021 | −12.955 | −2.604 | 0.00 | 0.00 |
| 135 | N | ALA | 10 | 5.334 | −12.183 | −4.136 | 0.00 | 0.00 |
| 136 | CA | ALA | 10 | 5.841 | −12.839 | −5.343 | 0.00 | 0.00 |
| 137 | C | ALA | 10 | 6.926 | −13.859 | −4.988 | 0.00 | 0.00 |
| 138 | O | ALA | 10 | 8.039 | −13.429 | −4.672 | 0.00 | 0.00 |
| 139 | CB | ALA | 10 | 6.336 | −11.770 | −6.326 | 0.00 | 0.00 |
| 140 | H | ALA | 10 | 5.206 | −11.186 | −4.204 | 0.00 | 0.00 |
| 141 | HA | ALA | 10 | 5.035 | −13.316 | −5.870 | 0.00 | 0.00 |
| 142 | HB1 | ALA | 10 | 5.513 | −11.108 | −6.595 | 0.00 | 0.00 |
| 143 | HB2 | ALA | 10 | 7.146 | −11.188 | −5.892 | 0.00 | 0.00 |
| 144 | HB3 | ALA | 10 | 6.696 | −12.253 | −7.235 | 0.00 | 0.00 |
| 145 | N | ALA | 11 | 6.715 | −15.185 | −5.011 | 0.00 | 0.00 |
| 146 | CA | ALA | 11 | 5.668 | −16.099 | −5.539 | 0.00 | 0.00 |
| 147 | C | ALA | 11 | 4.247 | −15.651 | −6.001 | 0.00 | 0.00 |
| 148 | O | ALA | 11 | 3.838 | −16.070 | −7.089 | 0.00 | 0.00 |
| 149 | CB | ALA | 11 | 5.507 | −17.231 | −4.515 | 0.00 | 0.00 |
| 150 | H | ALA | 11 | 7.523 | −15.676 | −4.642 | 0.00 | 0.00 |
| 151 | HA | ALA | 11 | 6.118 | −16.555 | −6.421 | 0.00 | 0.00 |
| 152 | HB1 | ALA | 11 | 4.930 | −18.046 | −4.955 | 0.00 | 0.00 |
| 153 | HB2 | ALA | 11 | 6.482 | −17.616 | −4.214 | 0.00 | 0.00 |
| 154 | HB3 | ALA | 11 | 4.976 | −16.860 | −3.640 | 0.00 | 0.00 |
| 155 | N | ALA | 12 | 3.450 | −14.902 | −5.228 | 0.00 | 0.00 |
| 156 | CA | ALA | 12 | 2.073 | −14.482 | −5.575 | 0.00 | 0.00 |
| 157 | C | ALA | 12 | 1.831 | −12.949 | −5.604 | 0.00 | 0.00 |
| 158 | O | ALA | 12 | 2.705 | −12.157 | −5.266 | 0.00 | 0.00 |
| 159 | CB | ALA | 12 | 1.119 | −15.190 | −4.606 | 0.00 | 0.00 |
| 160 | H | ALA | 12 | 3.813 | −14.604 | −4.327 | 0.00 | 0.00 |
| 161 | HA | ALA | 12 | 1.832 | −14.838 | −6.579 | 0.00 | 0.00 |
| 162 | HB1 | ALA | 12 | 1.267 | −14.818 | −3.594 | 0.00 | 0.00 |
| 163 | HB2 | ALA | 12 | 0.083 | −15.017 | −4.900 | 0.00 | 0.00 |
| 164 | HB3 | ALA | 12 | 1.312 | −16.263 | −4.613 | 0.00 | 0.00 |
| 165 | N | ILE | 13 | 0.625 | −12.512 | −5.988 | 0.00 | 0.00 |
| 166 | CA | ILE | 13 | 0.146 | −11.116 | −5.900 | 0.00 | 0.00 |
| 167 | C | ILE | 13 | −1.239 | −11.133 | −5.243 | 0.00 | 0.00 |
| 168 | O | ILE | 13 | −2.069 | −11.964 | −5.623 | 0.00 | 0.00 |
| 169 | CB | ILE | 13 | 0.092 | −10.449 | −7.298 | 0.00 | 0.00 |
| 170 | CG1 | ILE | 13 | 1.458 | −10.387 | −8.022 | 0.00 | 0.00 |
| 171 | CG2 | ILE | 13 | −0.531 | −9.040 | −7.229 | 0.00 | 0.00 |
| 172 | CD1 | ILE | 13 | 2.519 | −9.484 | −7.379 | 0.00 | 0.00 |
| 173 | H | ILE | 13 | −0.073 | −13.200 | −6.233 | 0.00 | 0.00 |
| 174 | HA | ILE | 13 | 0.810 | −10.534 | −5.261 | 0.00 | 0.00 |
| 175 | HB | ILE | 13 | −0.565 | −11.057 | −7.923 | 0.00 | 0.00 |
| 176 | 2HG1 | ILE | 13 | 1.866 | −11.395 | −8.106 | 0.00 | 0.00 |
| 177 | 3HG1 | ILE | 13 | 1.290 | −10.029 | −9.037 | 0.00 | 0.00 |
| 178 | 1HG2 | ILE | 13 | −0.013 | −8.429 | −6.489 | 0.00 | 0.00 |
| 179 | 2HG2 | ILE | 13 | −0.466 | −8.557 | −8.204 | 0.00 | 0.00 |
| 180 | 3HG2 | ILE | 13 | −1.586 | −9.104 | −6.958 | 0.00 | 0.00 |
| 181 | 1HD1 | ILE | 13 | 2.715 | −9.798 | −6.357 | 0.00 | 0.00 |
| 182 | 2HD1 | ILE | 13 | 3.444 | −9.558 | −7.952 | 0.00 | 0.00 |
| 183 | 3HD1 | ILE | 13 | 2.191 | −8.444 | −7.384 | 0.00 | 0.00 |
| 184 | N | ILE | 14 | −1.486 | −10.255 | −4.261 | 0.00 | 0.00 |
| 185 | CA | ILE | 14 | −2.682 | −10.312 | −3.402 | 0.00 | 0.00 |
| 186 | C | ILE | 14 | −3.324 | −8.935 | −3.158 | 0.00 | 0.00 |
| 187 | O | ILE | 14 | −2.677 | −7.889 | −3.254 | 0.00 | 0.00 |
| 188 | CB | ILE | 14 | −2.369 | −11.026 | −2.059 | 0.00 | 0.00 |
| 189 | CG1 | ILE | 14 | −1.476 | −10.178 | −1.125 | 0.00 | 0.00 |
| 190 | CG2 | ILE | 14 | −1.774 | −12.429 | −2.285 | 0.00 | 0.00 |
| 191 | CD1 | ILE | 14 | −1.276 | −10.796 | 0.263 | 0.00 | 0.00 |
| 192 | H | ILE | 14 | −0.783 | −9.557 | −4.031 | 0.00 | 0.00 |
| 193 | HA | ILE | 14 | −3.438 | −10.913 | −3.909 | 0.00 | 0.00 |
| 194 | HB | ILE | 14 | −3.324 | −11.168 | −1.550 | 0.00 | 0.00 |
| 195 | 2HG1 | ILE | 14 | −0.500 | −10.028 | −1.586 | 0.00 | 0.00 |
| 196 | 3HG1 | ILE | 14 | −1.937 | −9.203 | −0.974 | 0.00 | 0.00 |
| 197 | 1HG2 | ILE | 14 | −0.743 | −12.357 | −2.630 | 0.00 | 0.00 |
| 198 | 2HG2 | ILE | 14 | −1.796 | −13.002 | −1.358 | 0.00 | 0.00 |
| 199 | 3HG2 | ILE | 14 | −2.364 | −12.966 | −3.027 | 0.00 | 0.00 |
| 200 | 1HD1 | ILE | 14 | −0.640 | −11.679 | 0.199 | 0.00 | 0.00 |
| 201 | 2HD1 | ILE | 14 | 0.797 | −10.064 | 0.909 | 0.00 | 0.00 |
| 202 | 3HD1 | ILE | 14 | −2.241 | −11.069 | 0.691 | 0.00 | 0.00 |
| 203 | N | ALA | 15 | −4.601 | −8.960 | −2.769 | 0.00 | 0.00 |
| 204 | CA | ALA | 15 | −5.316 | −7.840 | −2.159 | 0.00 | 0.00 |
| 205 | C | ALA | 15 | −5.646 | −8.146 | −0.684 | 0.00 | 0.00 |
| 206 | O | ALA | 15 | −5.759 | −9.311 | −0.293 | 0.00 | 0.00 |
| 207 | CB | ALA | 15 | −6.562 | −7.516 | −2.992 | 0.00 | 0.00 |
| 208 | H | ALA | 15 | −5.055 | −9.857 | −2.701 | 0.00 | 0.00 |
| 209 | HA | ALA | 15 | −4.676 | −6.957 | −2.171 | 0.00 | 0.00 |
| 210 | HB1 | ALA | 15 | −7.246 | −8.365 | −2.989 | 0.00 | 0.00 |
| 211 | HB2 | ALA | 15 | −7.069 | −6.647 | −2.570 | 0.00 | 0.00 |
| 212 | HB3 | ALA | 15 | −6.272 | −7.288 | −4.018 | 0.00 | 0.00 |
| 213 | N | LEU | 16 | −5.779 | −7.095 | 0.126 | 0.00 | 0.00 |
| 214 | CA | LEU | 16 | −6.004 | −7.136 | 1.577 | 0.00 | 0.00 |
| 215 | C | LEU | 16 | −7.027 | −6.068 | 1.995 | 0.00 | 0.00 |
| 216 | O | LEU | 16 | −7.119 | −5.013 | 1.370 | 0.00 | 0.00 |
| 217 | CB | LEU | 16 | −4.668 | −6.896 | 2.312 | 0.00 | 0.00 |
| 218 | CG | LEU | 16 | −3.590 | −7.979 | 2.108 | 0.00 | 0.00 |
| 219 | CD1 | LEU | 16 | −2.265 | −7.491 | 2.692 | 0.00 | 0.00 |
| 220 | CD2 | LEU | 16 | −3.959 | −9.289 | 2.804 | 0.00 | 0.00 |
| 221 | H | LEU | 16 | −5.697 | −6.170 | −0.290 | 0.00 | 0.00 |
| 222 | HA | LEU | 16 | −6.405 | −8.112 | 1.861 | 0.00 | 0.00 |
| 223 | HB2 | LEU | 16 | −4.269 | −5.938 | 1.974 | 0.00 | 0.00 |
| 224 | HB3 | LEU | 16 | −4.868 | −6.807 | 3.382 | 0.00 | 0.00 |
| 225 | HG | LEU | 16 | −3.437 | −8.165 | 1.046 | 0.00 | 0.00 |
| 226 | 1HD1 | LEU | 16 | −2.392 | −7.278 | 3.751 | 0.00 | 0.00 |
| 227 | 2HD1 | LEU | 16 | −1.500 | −8.256 | 2.565 | 0.00 | 0.00 |
| 228 | 3HD1 | LEU | 16 | −1.946 | −6.586 | 2.176 | 0.00 | 0.00 |
| 229 | 1HD2 | LEU | 16 | −4.862 | −9.704 | 2.358 | 0.00 | 0.00 |
| 230 | 2HD2 | LEU | 16 | −3.155 | −10.014 | 2.687 | 0.00 | 0.00 |
| 231 | 52 | LEU | 16 | −4.128 | −9.116 | 3.866 | 0.00 | 0.00 |
| 232 | N | ALA | 17 | −7.763 | −6.316 | 3.077 | 0.00 | 0.00 |
| 233 | CA | ALA | 17 | −8.737 | −5.373 | 3.643 | 0.00 | 0.00 |
| 234 | C | ALA | 17 | −8.359 | −5.024 | 5.092 | 0.00 | 0.00 |
| 235 | O | ALA | 17 | −8.193 | −5.941 | 5.905 | 0.00 | 0.00 |
| 236 | CB | ALA | 17 | −10.129 | −6.005 | 3.555 | 0.00 | 0.00 |
| 237 | H | ALA | 17 | −7.612 | −7.185 | 3.575 | 0.00 | 0.00 |
| 238 | HA | ALA | 17 | −8.746 | −4.443 | 3.065 | 0.00 | 0.00 |
| 239 | HB1 | ALA | 17 | −10.126 | −6.972 | 4.059 | 0.00 | 0.00 |
| 240 | HB2 | ALA | 17 | −10.859 | −5.364 | 4.047 | 0.00 | 0.00 |
| 241 | HB3 | ALA | 17 | −10.410 | −6.141 | 2.510 | 0.00 | 0.00 |
| 242 | N | VAL | 18 | −8.230 | −3.726 | 5.411 | 0.00 | 0.00 |
| 243 | CA | VAL | 18 | −7.728 | −3.246 | 6.720 | 0.00 | 0.00 |
| 244 | C | VAL | 18 | −8.627 | −2.196 | 7.349 | 0.00 | 0.00 |
| 245 | O | VAL | 18 | −8.747 | −1.076 | 6.809 | 0.00 | 0.00 |
| 246 | CB | VAL | 18 | −6.263 | −2.757 | 6.616 | 0.00 | 0.00 |
| 247 | CG1 | VAL | 18 | −5.737 | −2.296 | 7.977 | 0.00 | 0.00 |
| 248 | CG2 | VAL | 18 | −5.347 | −3.890 | 6.117 | 0.00 | 0.00 |
| 249 | OXT | VAL | 18 | −9.198 | −2.496 | 8.421 | 0.00 | 0.00 |
| 250 | H | VAL | 18 | −8.395 | −3.024 | 4.699 | 0.00 | 0.00 |
| 251 | HA | VAL | 18 | −7.730 | −4.076 | 7.427 | 0.00 | 0.00 |
| 252 | HB | VAL | 18 | −6.209 | −1.930 | 5.916 | 0.00 | 0.00 |
| 253 | 1HG1 | VAL | 18 | −5.853 | −3.089 | 8.715 | 0.00 | 0.00 |
| 254 | 2HG1 | VAL | 18 | −4.680 | −2.034 | 7.900 | 0.00 | 0.00 |
| 255 | 3HG1 | VAL | 18 | −6.280 | −1.411 | 8.312 | 0.00 | 0.00 |
| 256 | 1HG2 | VAL | 18 | −5.605 | −4.162 | 5.098 | 0.00 | 0.00 |
| 257 | 2HG2 | VAL | 18 | −4.310 | −3.559 | 6.126 | 0.00 | 0.00 |
| 258 | 3HG2 | VAL | 18 | −5.446 | −4.763 | 6.761 | 0.00 | 0.00 |
| 259 | N | ALA | 19 | 2.334 | 14.833 | 4.025 | 0.00 | 0.00 |
| 260 | CA | ALA | 19 | 3.549 | 14.187 | 3.493 | 0.00 | 0.00 |
| 261 | C | ALA | 19 | 3.205 | 12.758 | 3.061 | 0.00 | 0.00 |
| 262 | O | ALA | 19 | 2.063 | 12.504 | 2.707 | 0.00 | 0.00 |
| 263 | CB | ALA | 19 | 4.149 | 15.003 | 2.341 | 0.00 | 0.00 |
| 264 | HA | ALA | 19 | 4.281 | 14.123 | 4.296 | 0.00 | 0.00 |
| 265 | HB1 | ALA | 19 | 5.059 | 14.523 | 1.978 | 0.00 | 0.00 |
| 266 | HB2 | ALA | 19 | 3.433 | 15.075 | 1.519 | 0.00 | 0.00 |
| 267 | HB3 | ALA | 19 | 4.397 | 16.007 | 2.689 | 0.00 | 0.00 |
| 268 | H1 | ALA | 19 | 1.983 | 14.274 | 4.796 | 0.00 | 0.00 |
| 269 | H2 | ALA | 19 | 1.626 | 14.891 | 3.304 | 0.00 | 0.00 |
| 270 | H3 | ALA | 19 | 2.525 | 15.760 | 4.382 | 0.00 | 0.00 |
| 271 | N | ALA | 20 | 4.110 | 11.781 | 3.061 | 0.00 | 0.00 |
| 272 | CA | ALA | 20 | 5.521 | 11.831 | 3.432 | 0.00 | 0.00 |
| 273 | C | ALA | 20 | 6.501 | 11.319 | 2.344 | 0.00 | 0.00 |
| 274 | O | ALA | 20 | 7.421 | 12.071 | 2.046 | 0.00 | 0.00 |
| 275 | CB | ALA | 20 | 5.702 | 11.163 | 4.800 | 0.00 | 0.00 |
| 276 | H | ALA | 20 | 3.739 | 10.868 | 2.827 | 0.00 | 0.00 |
| 277 | HA | ALA | 20 | 5.806 | 12.872 | 3.579 | 0.00 | 0.00 |
| 278 | HB1 | ALA | 20 | 5.264 | 10.169 | 4.802 | 0.00 | 0.00 |
| 279 | HB2 | ALA | 20 | 6.764 | 11.098 | 5.042 | 0.00 | 0.00 |
| 280 | HB3 | ALA | 20 | 5.203 | 11.760 | 5.564 | 0.00 | 0.00 |
| 281 | N | LEU | 21 | 6.434 | 10.156 | 1.673 | 0.00 | 0.00 |
| 282 | CA | LEU | 21 | 5.622 | 8.917 | 1.732 | 0.00 | 0.00 |
| 283 | C | LEU | 21 | 4.093 | 9.048 | 1.613 | 0.00 | 0.00 |
| 284 | O | LEU | 21 | 3.387 | 9.122 | 2.619 | 0.00 | 0.00 |
| 285 | CB | LEU | 21 | 6.074 | 7.966 | 2.861 | 0.00 | 0.00 |
| 286 | CG | LEU | 21 | 7.588 | 7.706 | 2.962 | 0.00 | 0.00 |
| 287 | CD1 | LEU | 21 | 7.859 | 6.720 | 4.101 | 0.00 | 0.00 |
| 288 | CD2 | LEU | 21 | 8.161 | 7.110 | 1.676 | 0.00 | 0.00 |
| 289 | H | LEU | 21 | 7.168 | 10.111 | 0.979 | 0.00 | 0.00 |
| 290 | HA | LEU | 21 | 5.894 | 8.380 | 0.824 | 0.00 | 0.00 |
| 291 | HB2 | LEU | 21 | 5.723 | 8.344 | 3.816 | 0.00 | 0.00 |
| 292 | HB3 | LEU | 21 | 5.579 | 7.008 | 2.698 | 0.00 | 0.00 |
| 293 | HG | LEU | 21 | 8.107 | 8.638 | 3.186 | 0.00 | 0.00 |
| 294 | 1HD1 | LEU | 21 | 7.371 | 5.767 | 3.897 | 0.00 | 0.00 |
| 295 | 2HD1 | LEU | 21 | 8.933 | 6.560 | 4.197 | 0.00 | 0.00 |
| 296 | 3HD1 | LEU | 21 | 7.481 | 7.128 | 5.037 | 0.00 | 0.00 |
| 297 | 1HD2 | LEU | 21 | 8.077 | 7.828 | 0.863 | 0.00 | 0.00 |
| 298 | 2HD2 | LEU | 21 | 9.219 | 6.891 | 1.814 | 0.00 | 0.00 |
| 299 | 3HD2 | LEU | 21 | 7.627 | 6.199 | 1.409 | 0.00 | 0.00 |
| 300 | N | VAL | 22 | 3.589 | 9.051 | 0.377 | 0.00 | 0.00 |
| 301 | CA | VAL | 22 | 2.153 | 9.000 | 0.033 | 0.00 | 0.00 |
| 302 | C | VAL | 22 | 1.744 | 7.574 | −0.369 | 0.00 | 0.00 |
| 303 | O | VAL | 22 | 2.534 | 6.829 | −0.950 | 0.00 | 0.00 |
| 304 | CB | VAL | 22 | 1.815 | 10.050 | −1.050 | 0.00 | 0.00 |
| 305 | CG1 | VAL | 22 | 0.395 | 9.938 | −1.620 | 0.00 | 0.00 |
| 306 | CG2 | VAL | 22 | 1.967 | 11.469 | −0.482 | 0.00 | 0.00 |
| 307 | H | VAL | 22 | 4.248 | 8.957 | −0.393 | 0.00 | 0.00 |
| 308 | HA | VAL | 22 | 1.568 | 9.253 | 0.918 | 0.00 | 0.00 |
| 309 | HB | VAL | 22 | 2.517 | 9.948 | −1.876 | 0.00 | 0.00 |
| 310 | 1HG1 | VAL | 22 | −0.342 | 9.992 | −0.818 | 0.00 | 0.00 |
| 311 | 2HG1 | VAL | 22 | 0.213 | 10.746 | −2.328 | 0.00 | 0.00 |
| 312 | 3HG1 | VAL | 22 | 0.277 | 8.996 | −2.159 | 0.00 | 0.00 |
| 313 | 1HG2 | VAL | 22 | 2.979 | 11.620 | −0.111 | 0.00 | 0.00 |
| 314 | 2HG2 | VAL | 22 | 1.774 | 12.203 | −1.264 | 0.00 | 0.00 |
| 315 | 3HG2 | VAL | 22 | 1.257 | 11.619 | 0.332 | 0.00 | 0.00 |
| 316 | N | PHE | 23 | 0.507 | 7.190 | −0.051 | 0.00 | 0.00 |
| 317 | CA | PHE | 23 | −0.062 | 5.854 | −0.266 | 0.00 | 0.00 |
| 318 | C | PHE | 23 | −1.426 | 5.941 | −0.975 | 0.00 | 0.00 |
| 319 | O | PHE | 23 | −2.013 | 7.019 | −1.071 | 0.00 | 0.00 |
| 320 | CB | PHE | 23 | −0.170 | 5.134 | 1.091 | 0.00 | 0.00 |
| 321 | CG | PHE | 23 | 1.157 | 4.906 | 1.796 | 0.00 | 0.00 |
| 322 | CD1 | PHE | 23 | 1.807 | 3.661 | 1.693 | 0.00 | 0.00 |
| 323 | CD2 | PHE | 23 | 1.747 | 5.937 | 2.554 | 0.00 | 0.00 |
| 324 | CE1 | PHE | 23 | 3.035 | 3.450 | 2.344 | 0.00 | 0.00 |
| 325 | CE2 | PHE | 23 | 2.991 | 5.736 | 3.177 | 0.00 | 0.00 |
| 326 | CZ | PHE | 23 | 3.635 | 4.490 | 3.073 | 0.00 | 0.00 |
| 327 | H | PHE | 23 | −0.096 | 7.868 | 0.402 | 0.00 | 0.00 |
| 328 | HA | PHE | 23 | 0.603 | 5.272 | −0.907 | 0.00 | 0.00 |
| 329 | HB2 | PHE | 23 | −0.814 | 5.715 | 1.750 | 0.00 | 0.00 |
| 330 | HB3 | PHE | 23 | −0.651 | 4.166 | 0.942 | 0.00 | 0.00 |
| 331 | HD1 | PHE | 23 | 1.368 | 2.862 | 1.113 | 0.00 | 0.00 |
| 332 | HD2 | PHE | 23 | 1.253 | 6.894 | 2.645 | 0.00 | 0.00 |
| 333 | HE1 | PHE | 23 | 3.521 | 2.487 | 2.270 | 0.00 | 0.00 |
| 334 | HE2 | PHE | 23 | 3.440 | 6.537 | 3.744 | 0.00 | 0.00 |
| 335 | HZ | PHE | 23 | 4.584 | 4.325 | 3.565 | 0.00 | 0.00 |
| 336 | N | PHE | 24 | −1.952 | 4.811 | −1.457 | 0.00 | 0.00 |
| 337 | CA | PHE | 24 | −3.236 | 4.730 | −2.171 | 0.00 | 0.00 |
| 338 | C | PHE | 24 | −4.070 | 3.528 | −1.708 | 0.00 | 0.00 |
| 339 | O | PHE | 24 | −3.512 | 2.531 | −1.248 | 0.00 | 0.00 |
| 340 | CB | PHE | 24 | −2.994 | 4.670 | −3.690 | 0.00 | 0.00 |
| 341 | CG | PHE | 24 | −2.207 | 5.840 | −4.252 | 0.00 | 0.00 |
| 342 | CD1 | PHE | 24 | −2.856 | 7.064 | −4.510 | 0.00 | 0.00 |
| 343 | CD2 | PHE | 24 | −0.824 | 5.721 | −4.489 | 0.00 | 0.00 |
| 344 | CE1 | PHE | 24 | −2.122 | 8.165 | −4.985 | 0.00 | 0.00 |
| 345 | CE2 | PHE | 24 | −0.092 | 6.822 | −4.967 | 0.00 | 0.00 |
| 346 | CZ | PHE | 24 | −0.740 | 8.043 | −5.211 | 0.00 | 0.00 |
| 347 | H | PHE | 24 | −1.467 | 3.940 | −1.297 | 0.00 | 0.00 |
| 348 | HA | PHE | 24 | −3.818 | 5.625 | −1.959 | 0.00 | 0.00 |
| 349 | HB2 | PHE | 24 | −2.468 | 3.743 | −3.925 | 0.00 | 0.00 |
| 350 | HB3 | PHE | 24 | −3.960 | 4.631 | −4.196 | 0.00 | 0.00 |
| 351 | HD1 | PHE | 24 | −3.915 | 7.161 | −4.319 | 0.00 | 0.00 |
| 352 | HD2 | PHE | 24 | −0.317 | 4.788 | −4.287 | 0.00 | 0.00 |
| 353 | HE1 | PHE | 24 | −2.611 | 9.113 | −5.160 | 0.00 | 0.00 |
| 354 | HE2 | PHE | 24 | 0.975 | 6.740 | −5.130 | 0.00 | 0.00 |
| 355 | HZ | PHE | 24 | −0.168 | 8.892 | −5.557 | 0.00 | 0.00 |
| 356 | N | ALA | 25 | −5.396 | 3.614 | −1.849 | 0.00 | 0.00 |
| 357 | CA | ALA | 25 | −6.333 | 2.545 | −1.495 | 0.00 | 0.00 |
| 358 | C | ALA | 25 | −7.562 | 2.514 | −2.422 | 0.00 | 0.00 |
| 359 | O | ALA | 25 | −8.029 | 3.553 | −2.900 | 0.00 | 0.00 |
| 360 | CB | ALA | 25 | −6.763 | 2.725 | −0.031 | 0.00 | 0.00 |
| 361 | H | ALA | 25 | −5.786 | 4.464 | −2.241 | 0.00 | 0.00 |
| 362 | HA | ALA | 25 | −5.827 | 1.582 | −1.582 | 0.00 | 0.00 |
| 363 | HB1 | ALA | 25 | −7.300 | 3.666 | 0.090 | 0.00 | 0.00 |
| 364 | HB2 | ALA | 25 | −7.411 | 1.900 | 0.267 | 0.00 | 0.00 |
| 365 | HB3 | ALA | 25 | −5.884 | 2.727 | 0.614 | 0.00 | 0.00 |
| 366 | N | GLU | 26 | −8.137 | 1.325 | −2.624 | 0.00 | 0.00 |
| 367 | CA | GLU | 26 | −9.482 | 1.178 | −3.180 | 0.00 | 0.00 |
| 368 | C | GLU | 26 | −10.514 | 1.311 | −2.046 | 0.00 | 0.00 |
| 369 | O | GLU | 26 | −10.919 | 0.342 | −1.407 | 0.00 | 0.00 |
| 370 | CB | GLU | 26 | −9.624 | −0.114 | −4.016 | 0.00 | 0.00 |
| 371 | CG | GLU | 26 | −10.977 | −0.133 | −4.751 | 0.00 | 0.00 |
| 372 | CD | GLU | 26 | −11.447 | −1.517 | −5.213 | 0.00 | 0.00 |
| 373 | OE1 | GLU | 26 | −11.895 | −2.313 | −4.355 | 0.00 | 0.00 |
| 374 | OE2 | GLU | 26 | −11.496 | −1.779 | −6.439 | 0.00 | 0.00 |
| 375 | H | GLU | 26 | −7.740 | 0.518 | −2.148 | 0.00 | 0.00 |
| 376 | HA | GLU | 26 | −9.657 | 2.003 | −3.872 | 0.00 | 0.00 |
| 377 | HB2 | GLU | 26 | −8.823 | −0.162 | −4.755 | 0.00 | 0.00 |
| 378 | HB3 | GLU | 26 | −9.539 | −0.981 | −3.367 | 0.00 | 0.00 |
| 379 | HG2 | GLU | 26 | −11.746 | 0.254 | −4.083 | 0.00 | 0.00 |
| 380 | HG3 | GLU | 26 | −10.919 | 0.541 | −5.607 | 0.00 | 0.00 |
| 381 | N | ASP | 27 | −10.969 | 2.540 | −1.810 | 0.00 | 0.00 |
| 382 | CA | ASP | 27 | −12.138 | 2.862 | −0.975 | 0.00 | 0.00 |
| 383 | C | ASP | 27 | −13.405 | 3.008 | −1.851 | 0.00 | 0.00 |
| 384 | O | ASP | 27 | −14.243 | 3.879 | −1.636 | 0.00 | 0.00 |
| 385 | CB | ASP | 27 | −11.811 | 4.115 | −0.148 | 0.00 | 0.00 |
| 386 | CG | ASP | 27 | −12.758 | 4.368 | 1.029 | 0.00 | 0.00 |
| 387 | OD1 | ASP | 27 | −13.450 | 3.444 | 1.512 | 0.00 | 0.00 |
| 388 | OD2 | ASP | 27 | −12.770 | 5.511 | 1.543 | 0.00 | 0.00 |
| 389 | H | ASP | 27 | −10.533 | 3.308 | −2.304 | 0.00 | 0.00 |
| 390 | HA | ASP | 27 | −12.318 | 2.040 | −0.282 | 0.00 | 0.00 |
| 391 | HB2 | ASP | 27 | −10.806 | 4.004 | 0.260 | 0.00 | 0.00 |
| 392 | HB3 | ASP | 27 | −11.808 | 4.986 | −0.805 | 0.00 | 0.00 |
| 393 | N | ALA | 28 | −13.467 | 2.225 | −2.938 | 0.00 | 0.00 |
| 394 | CA | ALA | 28 | 14.204 | 2.596 | −4.146 | 0.00 | 0.00 |
| 395 | C | ALA | 28 | −15.652 | 2.063 | −4.211 | 0.00 | 0.00 |
| 396 | O | ALA | 28 | −15.879 | 0.874 | −3.958 | 0.00 | 0.00 |
| 397 | CB | ALA | 28 | −13.390 | 2.162 | −5.372 | 0.00 | 0.00 |
| 398 | H | ALA | 28 | −12.747 | 1.527 | −3.027 | 0.00 | 0.00 |
| 399 | HA | ALA | 28 | −14.235 | 3.679 | −4.143 | 0.00 | 0.00 |
| 400 | HB1 | ALA | 28 | −12.364 | 2.521 | −5.285 | 0.00 | 0.00 |
| 401 | HB2 | ALA | 28 | −13.400 | 1.076 | −5.459 | 0.00 | 0.00 |
| 402 | HB3 | ALA | 28 | −13.822 | 2.572 | −6.282 | 0.00 | 0.00 |
| 403 | N | ALA | 29 | −16.656 | 2.851 | −4.625 | 0.00 | 0.00 |
| 404 | CA | ALA | 29 | −16.647 | 4.268 | −5.045 | 0.00 | 0.00 |
| 405 | C | ALA | 29 | −15.606 | 4.631 | −6.137 | 0.00 | 0.00 |
| 406 | O | ALA | 29 | −15.681 | 4.100 | −7.243 | 0.00 | 0.00 |
| 407 | CB | ALA | 29 | −16.665 | 5.180 | −3.804 | 0.00 | 0.00 |
| 408 | H | ALA | 29 | −17.554 | 2.396 | −4.644 | 0.00 | 0.00 |
| 409 | HA | ALA | 29 | −17.605 | 4.437 | −5.537 | 0.00 | 0.00 |
| 410 | HB1 | ALA | 29 | −16.804 | 6.218 | −4.103 | 0.00 | 0.00 |
| 411 | HB2 | ALA | 29 | −17.490 | 4.896 | −3.149 | 0.00 | 0.00 |
| 412 | HB3 | ALA | 29 | −15.736 | 5.100 | −3.245 | 0.00 | 0.00 |
| 413 | N | ALA | 30 | −14.626 | 5.488 | −5.821 | 0.00 | 0.00 |
| 414 | CA | ALA | 30 | −13.432 | 5.771 | −6.630 | 0.00 | 0.00 |
| 415 | C | ALA | 30 | −12.135 | 5.498 | −5.829 | 0.00 | 0.00 |
| 416 | O | ALA | 30 | −12.186 | 5.284 | −4.617 | 0.00 | 0.00 |
| 417 | CB | ALA | 30 | −13.516 | 7.219 | −7.133 | 0.00 | 0.00 |
| 418 | H | ALA | 30 | −14.608 | 5.838 | −4.875 | 0.00 | 0.00 |
| 419 | HA | ALA | 30 | −13.418 | 5.113 | −7.502 | 0.00 | 0.00 |
| 420 | HB1 | ALA | 30 | −13.505 | 7.908 | −6.288 | 0.00 | 0.00 |
| 421 | HB2 | ALA | 30 | −12.665 | 7.439 | −7.779 | 0.00 | 0.00 |
| 422 | HB3 | ALA | 30 | −14.434 | 7.359 | −7.705 | 0.00 | 0.00 |
| 423 | N | ILE | 31 | −10.975 | 5.498 | −6.495 | 0.00 | 0.00 |
| 424 | CA | ILE | 31 | −9.659 | 5.307 | −5.851 | 0.00 | 0.00 |
| 425 | C | ILE | 31 | −9.282 | 6.542 | −5.013 | 0.00 | 0.00 |
| 426 | O | ILE | 31 | −9.556 | 7.669 | −5.425 | 0.00 | 0.00 |
| 427 | CB | ILE | 31 | −8.577 | 4.982 | −6.913 | 0.00 | 0.00 |
| 428 | CG1 | ILE | 31 | −8.944 | 3.773 | −7.809 | 0.00 | 0.00 |
| 429 | CG2 | ILE | 31 | −7.191 | 4.760 | −6.276 | 0.00 | 0.00 |
| 430 | CD1 | ILE | 31 | −9.188 | 2.453 | −7.066 | 0.00 | 0.00 |
| 431 | H | ILE | 31 | −10.984 | 5.739 | −7.476 | 0.00 | 0.00 |
| 432 | HA | ILE | 31 | −9.728 | 4.464 | −5.164 | 0.00 | 0.00 |
| 433 | HB | ILE | 31 | −8.491 | 5.848 | −7.572 | 0.00 | 0.00 |
| 434 | 2HG1 | ILE | 31 | −9.837 | 4.012 | −8.387 | 0.00 | 0.00 |
| 435 | 3HG1 | ILE | 31 | −8.139 | 3.616 | −8.530 | 0.00 | 0.00 |
| 436 | 1HG2 | ILE | 31 | −7.242 | 3.994 | −5.502 | 0.00 | 0.00 |
| 437 | 2HG2 | ILE | 31 | −6.478 | 4.446 | −7.039 | 0.00 | 0.00 |
| 438 | 3HG2 | ILE | 31 | −6.821 | 5.686 | −5.836 | 0.00 | 0.00 |
| 439 | 1HD1 | ILE | 31 | −10.027 | 2.561 | −6.380 | 0.00 | 0.00 |
| 440 | 2HD1 | ILE | 31 | −9.428 | 1.673 | −7.790 | 0.00 | 0.00 |
| 441 | 3HD1 | ILE | 31 | −8.299 | 2.153 | −6.513 | 0.00 | 0.00 |
| 442 | N | ILE | 32 | −8.635 | 6.346 | −3.856 | 0.00 | 0.00 |
| 443 | CA | ILE | 32 | −8.216 | 7.435 | −2.954 | 0.00 | 0.00 |
| 444 | C | ILE | 32 | −6.708 | 7.427 | −2.666 | 0.00 | 0.00 |
| 445 | O | ILE | 32 | −6.035 | 6.404 | −2.797 | 0.00 | 0.00 |
| 446 | CB | ILE | 32 | −9.050 | 7.457 | −1.651 | 0.00 | 0.00 |
| 447 | CG1 | ILE | 32 | −8.732 | 6.281 | −0.698 | 0.00 | 0.00 |
| 448 | CG2 | ILE | 32 | −10.556 | 7.558 | −1.957 | 0.00 | 0.00 |
| 449 | CD1 | ILE | 32 | −9.198 | 6.543 | 0.739 | 0.00 | 0.00 |
| 450 | H | ILE | 32 | −8.403 | 5.395 | −3.583 | 0.00 | 0.00 |
| 451 | HA | ILE | 32 | −8.414 | 8.383 | −3.456 | 0.00 | 0.00 |
| 452 | HB | ILE | 32 | −8.775 | 8.375 | −1.129 | 0.00 | 0.00 |
| 453 | 2HG1 | ILE | 32 | −9.192 | 5.367 | −1.074 | 0.00 | 0.00 |
| 454 | 3HG1 | ILE | 32 | −7.656 | 6.119 | −0.652 | 0.00 | 0.00 |
| 455 | 1HG2 | ILE | 32 | −10.917 | 6.630 | −2.403 | 0.00 | 0.00 |
| 456 | 2HG2 | ILE | 32 | −11.116 | 7.751 | −1.042 | 0.00 | 0.00 |
| 457 | 3HG2 | ILE | 32 | −10.736 | 8.376 | −2.655 | 0.00 | 0.00 |
| 458 | 1HD1 | ILE | 32 | −10.285 | 6.607 | 0.784 | 0.00 | 0.00 |
| 459 | 2HD1 | ILE | 32 | −8.865 | 5.727 | 1.377 | 0.00 | 0.00 |
| 460 | 3HD1 | ILE | 32 | −8.764 | 7.473 | 1.108 | 0.00 | 0.00 |
| 461 | N | ALA | 33 | −6.197 | 8.581 | −2.228 | 0.00 | 0.00 |
| 462 | CA | ALA | 33 | −4.832 | 8.778 | −1.740 | 0.00 | 0.00 |
| 463 | C | ALA | 33 | −4.812 | 9.038 | −0.223 | 0.00 | 0.00 |
| 464 | O | ALA | 33 | −5.749 | 9.624 | 0.328 | 0.00 | 0.00 |
| 465 | CB | ALA | 33 | −4.191 | 9.931 | −2.523 | 0.00 | 0.00 |
| 466 | H | ALA | 33 | −6.827 | 9.360 | −2.115 | 0.00 | 0.00 |
| 467 | HA | ALA | 33 | −4.247 | 7.879 | −1.934 | 0.00 | 0.00 |
| 468 | HB1 | ALA | 33 | −4.694 | 10.870 | −2.287 | 0.00 | 0.00 |
| 469 | HB2 | ALA | 33 | −3.136 | 10.012 | −2.256 | 0.00 | 0.00 |
| 470 | HB3 | ALA | 33 | −4.271 | 9.744 | −3.594 | 0.00 | 0.00 |
| 471 | N | LEU | 34 | −3.730 | 8.640 | 0.446 | 0.00 | 0.00 |
| 472 | CA | LEU | 34 | −3.496 | 8.788 | 1.885 | 0.00 | 0.00 |
| 473 | C | LEU | 34 | −2.114 | 9.420 | 2.118 | 0.00 | 0.00 |
| 474 | O | LEU | 34 | −1.114 | 8.952 | 1.571 | 0.00 | 0.00 |
| 475 | CB | LEU | 34 | −3.608 | 7.412 | 2.574 | 0.00 | 0.00 |
| 476 | CG | LEU | 34 | −4.973 | 6.705 | 2.435 | 0.00 | 0.00 |
| 477 | CD1 | LEU | 34 | −4.880 | 5.287 | 2.999 | 0.00 | 0.00 |
| 478 | CD2 | LEU | 34 | −6.085 | 7.444 | 3.181 | 0.00 | 0.00 |
| 479 | H | LEU | 34 | −2.994 | 8.185 | −0.088 | 0.00 | 0.00 |
| 480 | HA | LEU | 34 | −4.245 | 9.455 | 2.314 | 0.00 | 0.00 |
| 481 | HB2 | LEU | 34 | −2.845 | 6.762 | 2.146 | 0.00 | 0.00 |
| 482 | HB3 | LEU | 34 | −3.382 | 7.532 | 3.634 | 0.00 | 0.00 |
| 483 | HG | LEU | 34 | −5.245 | 6.626 | 1.382 | 0.00 | 0.00 |
| 484 | 1HD1 | LEU | 34 | −4.628 | 5.320 | 4.060 | 0.00 | 0.00 |
| 485 | 2HD1 | LEU | 34 | −5.833 | 4.776 | 2.867 | 0.00 | 0.00 |
| 486 | 3HD1 | LEU | 34 | −4.109 | 4.731 | 2.466 | 0.00 | 0.00 |
| 487 | 1HD2 | LEU | 34 | −6.239 | 8.429 | 2.743 | 0.00 | 0.00 |
| 488 | 2HD2 | LEU | 34 | −7.017 | 6.885 | 3.100 | 0.00 | 0.00 |
| 489 | 3HD2 | LEU | 34 | −5.825 | 7.553 | 4.234 | 0.00 | 0.00 |
| 490 | N | ALA | 35 | −2.058 | 10.488 | 2.915 | 0.00 | 0.00 |
| 491 | CA | ALA | 35 | −0.872 | 11.334 | 3.065 | 0.00 | 0.00 |
| 492 | C | ALA | 35 | −0.519 | 11.585 | 4.546 | 0.00 | 0.00 |
| 493 | O | ALA | 35 | −1.323 | 12.137 | 5.308 | 0.00 | 0.00 |
| 494 | CB | ALA | 35 | −1.124 | 12.624 | 2.271 | 0.00 | 0.00 |
| 495 | H | ALA | 35 | −2.924 | 10.815 | 3.330 | 0.00 | 0.00 |
| 496 | HA | ALA | 35 | −0.012 | 10.839 | 2.611 | 0.00 | 0.00 |
| 497 | HB1 | ALA | 35 | −2.070 | 13.076 | 2.562 | 0.00 | 0.00 |
| 498 | HB2 | ALA | 35 | −0.321 | 13.335 | 2.447 | 0.00 | 0.00 |
| 499 | HB3 | ALA | 35 | −1.161 | 12.393 | 1.206 | 0.00 | 0.00 |
| 500 | N | VAL | 36 | 0.692 | 11.186 | 4.953 | 0.00 | 0.00 |
| 501 | CA | VAL | 36 | 1.184 | 11.172 | 6.348 | 0.00 | 0.00 |
| 502 | C | VAL | 36 | 1.637 | 12.542 | 6.835 | 0.00 | 0.00 |
| 503 | O | VAL | 36 | 2.490 | 13.172 | 6.167 | 0.00 | 0.00 |
| 504 | CB | VAL | 36 | 2.289 | 10.114 | 6.523 | 0.00 | 0.00 |
| 505 | CG1 | VAL | 36 | 2.761 | 10.034 | 7.980 | 0.00 | 0.00 |
| 506 | CG2 | VAL | 36 | 1.793 | 8.721 | 6.110 | 0.00 | 0.00 |
| 507 | OXT | VAL | 36 | 1.145 | 12.970 | 7.898 | 0.00 | 0.00 |
| 508 | H | VAL | 36 | 1.308 | 10.816 | 4.241 | 0.00 | 0.00 |
| 509 | HA | VAL | 36 | 0.361 | 10.886 | 6.999 | 0.00 | 0.00 |
| 510 | HB | VAL | 36 | 3.138 | 10.379 | 5.892 | 0.00 | 0.00 |
| 511 | 1HG1 | VAL | 36 | 1.915 | 9.832 | 8.636 | 0.00 | 0.00 |
| 512 | 2HG1 | VAL | 36 | 3.499 | 9.240 | 8.091 | 0.00 | 0.00 |
| 513 | 3HG1 | VAL | 36 | 3.227 | 10.973 | 8.280 | 0.00 | 0.00 |
| 514 | 1HG2 | VAL | 36 | 1.563 | 8.698 | 5.044 | 0.00 | 0.00 |
| 515 | 2HG2 | VAL | 36 | 2.568 | 7.978 | 6.298 | 0.00 | 0.00 |
| 516 | 3HG2 | VAL | 36 | 0.899 | 8.457 | 6.675 | 0.00 | 0.00 |
| 517 | N | ALA | 37 | 10.350 | −12.510 | 2.456 | 0.00 | 0.00 |
| 518 | CA | ALA | 37 | 8.990 | −12.005 | 2.194 | 0.00 | 0.00 |
| 519 | C | ALA | 37 | 8.966 | −10.481 | 2.345 | 0.00 | 0.00 |
| 520 | O | ALA | 37 | 9.831 | −9.819 | 1.779 | 0.00 | 0.00 |
| 521 | CB | ALA | 37 | 8.494 | −12.434 | 0.801 | 0.00 | 0.00 |
| 522 | HA | ALA | 37 | 8.325 | −12.441 | 2.934 | 0.00 | 0.00 |
| 523 | HB1 | ALA | 37 | 7.475 | −12.083 | 0.639 | 0.00 | 0.00 |
| 524 | HB2 | ALA | 37 | 9.120 | −12.005 | 0.019 | 0.00 | 0.00 |
| 525 | HB3 | ALA | 37 | 8.508 | −13.521 | 0.721 | 0.00 | 0.00 |
| 526 | H1 | ALA | 37 | 10.631 | −12.311 | 3.410 | 0.00 | 0.00 |
| 527 | H2 | ALA | 37 | 11.000 | −12.060 | 1.822 | 0.00 | 0.00 |
| 528 | H3 | ALA | 37 | 10.386 | −13.506 | 2.304 | 0.00 | 0.00 |
| 529 | N | ALA | 38 | 8.049 | −9.863 | 3.093 | 0.00 | 0.00 |
| 530 | CA | ALA | 38 | 6.891 | −10.407 | 3.816 | 0.00 | 0.00 |
| 531 | C | ALA | 38 | 5.927 | −11.223 | 2.922 | 0.00 | 0.00 |
| 532 | O | ALA | 38 | 6.104 | −12.432 | 2.802 | 0.00 | 0.00 |
| 533 | CB | ALA | 38 | 7.368 | −11.139 | 5.079 | 0.00 | 0.00 |
| 534 | H | ALA | 38 | 8.094 | −8.851 | 3.071 | 0.00 | 0.00 |
| 535 | HA | ALA | 38 | 6.324 | −9.562 | 4.197 | 0.00 | 0.00 |
| 536 | HB1 | ALA | 38 | 7.865 | −12.078 | 4.838 | 0.00 | 0.00 |
| 537 | HB2 | ALA | 38 | 8.051 | −10.507 | 5.647 | 0.00 | 0.00 |
| 538 | HB3 | ALA | 38 | 6.500 | −11.360 | 5.697 | 0.00 | 0.00 |
| 539 | N | LEU | 39 | 4.920 | −10.662 | 2.240 | 0.00 | 0.00 |
| 540 | CA | LEU | 39 | 4.402 | −9.279 | 2.204 | 0.00 | 0.00 |
| 541 | C | LEU | 39 | 5.404 | −8.147 | 1.882 | 0.00 | 0.00 |
| 542 | O | LEU | 39 | 6.189 | −7.718 | 2.729 | 0.00 | 0.00 |
| 543 | CB | LEU | 39 | 3.578 | −8.963 | 3.471 | 0.00 | 0.00 |
| 544 | CG | LEU | 39 | 2.430 | −9.935 | 3.804 | 0.00 | 0.00 |
| 545 | CD1 | LEU | 39 | 1.747 | −9.480 | 5.094 | 0.00 | 0.00 |
| 546 | CD2 | LEU | 39 | 1.375 | −9.984 | 2.700 | 0.00 | 0.00 |
| 547 | H | LEU | 39 | 4.412 | −11.322 | 1.663 | 0.00 | 0.00 |
| 548 | HA | LEU | 39 | 3.690 | −9.259 | 1.376 | 0.00 | 0.00 |
| 549 | HB2 | LEU | 39 | 4.249 | −8.926 | 4.328 | 0.00 | 0.00 |
| 550 | HB3 | LEU | 39 | 3.156 | −7.966 | 3.350 | 0.00 | 0.00 |
| 551 | HG | LEU | 29 | 2.828 | −10.938 | 3.962 | 0.00 | 0.00 |
| 552 | 1HD1 | LEU | 39 | 1.343 | −8.477 | 4.970 | 0.00 | 0.00 |
| 553 | 2HD1 | LEU | 39 | 0.935 | −10.161 | 5.346 | 0.00 | 0.00 |
| 554 | 3HD1 | LEU | 39 | 2.466 | −9.482 | 5.914 | 0.00 | 0.00 |
| 555 | 1HD2 | LEU | 39 | 1.798 | −10.419 | 1.795 | 0.00 | 0.00 |
| 556 | 2HD2 | LEU | 39 | 0.540 | −10.608 | 3.016 | 0.00 | 0.00 |
| 557 | 3HD2 | LEU | 39 | 1.011 | −8.979 | 2.484 | 0.00 | 0.00 |
| 558 | N | VAL | 40 | 5.314 | −7.606 | 0.667 | 0.00 | 0.00 |
| 559 | CA | VAL | 40 | 5.981 | −6.367 | 0.241 | 0.00 | 0.00 |
| 560 | C | VAL | 40 | 4.929 | −5.354 | −0.222 | 0.00 | 0.00 |
| 561 | O | VAL | 40 | 4.010 | −5.687 | −0.972 | 0.00 | 0.00 |
| 562 | CB | VAL | 40 | 7.046 | −6.652 | −0.838 | 0.00 | 0.00 |
| 563 | CG1 | VAL | 40 | 7.711 | −5.373 | −1.362 | 0.00 | 0.00 |
| 564 | CG2 | VAL | 40 | 8.155 | −7.564 | −0.293 | 0.00 | 0.00 |
| 565 | H | VAL | 40 | 4.694 | −8.043 | −0.012 | 0.00 | 0.00 |
| 566 | HA | VAL | 40 | 6.496 | −5.926 | 1.095 | 0.00 | 0.00 |
| 567 | HB | VAL | 40 | 6.577 | −7.160 | −1.679 | 0.00 | 0.00 |
| 568 | 1HG1 | VAL | 40 | 8.152 | −4.816 | −0.535 | 0.00 | 0.00 |
| 569 | 2HG1 | VAL | 40 | 8.490 | −5.625 | −2.081 | 0.00 | 0.00 |
| 570 | 3HG1 | VAL | 40 | 6.976 | −4.744 | −1.867 | 0.00 | 0.00 |
| 571 | 1HG2 | VAL | 40 | 7.738 | −8.532 | −0.016 | 0.00 | 0.00 |
| 572 | 2HG2 | VAL | 40 | 8.913 | −7.729 | −1.059 | 0.00 | 0.00 |
| 573 | 3HG2 | VAL | 40 | 8.617 | −7.108 | 0.582 | 0.00 | 0.00 |
| 574 | N | PHE | 41 | 5.068 | −4.112 | 0.230 | 0.00 | 0.00 |
| 575 | CA | PHE | 41 | 4.165 | −2.989 | −0.030 | 0.00 | 0.00 |
| 576 | C | PHE | 41 | 4.879 | −1.894 | −0.836 | 0.00 | 0.00 |
| 577 | O | PHE | 41 | 6.103 | −1.917 | −0.963 | 0.00 | 0.00 |
| 578 | CB | PHE | 41 | 3.642 | −2.444 | 1.309 | 0.00 | 0.00 |
| 579 | CG | PHE | 41 | 3.180 | −3.504 | 2.295 | 0.00 | 0.00 |
| 580 | CD1 | PHE | 41 | 1.993 | −4.225 | 2.059 | 0.00 | 0.00 |
| 581 | CD2 | PHE | 41 | 3.948 | −3.778 | 3.444 | 0.00 | 0.00 |
| 582 | CE1 | PHE | 41 | 1.569 | −5.201 | 2.978 | 0.00 | 0.00 |
| 583 | CE2 | PHE | 41 | 3.518 | −4.747 | 4.366 | 0.00 | 0.00 |
| 584 | CZ | PHE | 41 | 2.324 | −5.451 | 4.138 | 0.00 | 0.00 |
| 585 | H | PHE | 41 | 5.880 | −3.914 | 0.807 | 0.00 | 0.00 |
| 586 | HA | PHE | 41 | 3.312 | −3.336 | −0.615 | 0.00 | 0.00 |
| 587 | HB2 | PHE | 41 | 4.435 | −1.858 | 1.776 | 0.00 | 0.00 |
| 588 | HB3 | PHE | 41 | 2.811 | −1.764 | 1.114 | 0.00 | 0.00 |
| 589 | HD1 | PHE | 41 | 1.402 | −4.022 | 1.176 | 0.00 | 0.00 |
| 590 | HD2 | PHE | 41 | 4.866 | −3.237 | 3.626 | 0.00 | 0.00 |
| 591 | HE1 | PHE | 41 | 0.645 | 5.737 | 2.812 | 0.00 | 0.00 |
| 592 | HE2 | PHE | 41 | 4.095 | −4.936 | 5.260 | 0.00 | 0.00 |
| 593 | HZ | PHE | 41 | 1.976 | −6.171 | 4.864 | 0.00 | 0.00 |
| 594 | N | PHE | 42 | 4.142 | −0.907 | −1.349 | 0.00 | 0.00 |
| 595 | CA | PHE | 42 | 4.695 | 0.186 | −2.160 | 0.00 | 0.00 |
| 596 | C | PHE | 42 | 4.269 | 1.560 | −1.633 | 0.00 | 0.00 |
| 597 | O | PHE | 42 | 3.168 | 1.705 | −1.102 | 0.00 | 0.00 |
| 598 | CB | PHE | 42 | 4.302 | −0.004 | −3.634 | 0.00 | 0.00 |
| 599 | CG | PHE | 42 | 4.688 | −1.359 | −4.200 | 0.00 | 0.00 |
| 600 | CD1 | PHE | 42 | 6.016 | −1.604 | −4.600 | 0.00 | 0.00 |
| 601 | CD2 | PHE | 42 | 3.735 | −2.393 | −4.274 | 0.00 | 0.00 |
| 602 | CE1 | PHE | 42 | 6.390 | −2.879 | −5.061 | 0.00 | 0.00 |
| 603 | CE2 | PHE | 42 | 4.110 | −3.668 | −4.731 | 0.00 | 0.00 |
| 604 | CZ | PHE | 42 | 5.438 | −3.913 | −5.119 | 0.00 | 0.00 |
| 605 | H | PHE | 42 | 3.152 | −0.881 | −1.156 | 0.00 | 0.00 |
| 606 | HA | PHE | 42 | 5.782 | 0.1352 | −2.110 | 0.00 | 0.00 |
| 607 | HB2 | PHE | 42 | 3.224 | 0.131 | −3.732 | 0.00 | 0.00 |
| 608 | HB3 | PHE | 42 | 4.785 | 0.773 | −4.229 | 0.00 | 0.00 |
| 609 | HD1 | PHE | 42 | 6.753 | −0.816 | −4.530 | 0.00 | 0.00 |
| 610 | HD2 | PHE | 42 | 2.716 | −2.216 | −3.957 | 0.00 | 0.00 |
| 611 | HE1 | PHE | 42 | 7.414 | −3.069 | −5.355 | 0.00 | 0.00 |
| 612 | HE2 | PHE | 42 | 3.381 | −4.467 | −4.769 | 0.00 | 0.00 |
| 613 | HZ | PHE | 42 | 5.727 | −4.898 | −5.456 | 0.00 | 0.00 |
| 614 | N | ALA | 43 | 5.134 | 2.563 | −1.800 | 0.00 | 0.00 |
| 615 | CA | ALA | 43 | 4.883 | 3.947 | −1.403 | 0.00 | 0.00 |
| 616 | C | ALA | 43 | 5.410 | 4.939 | −2.452 | 0.00 | 0.00 |
| 611 | O | ALA | 43 | 6.459 | 4.715 | −3.066 | 0.00 | 0.00 |
| 618 | CB | ALA | 43 | 5.530 | 4.200 | −0.035 | 0.00 | 0.00 |
| 619 | H | ALA | 43 | 6.028 | 2.363 | −2.238 | 0.00 | 0.00 |
| 620 | HA | ALA | 43 | 3.807 | 4.105 | −1.303 | 0.00 | 0.00 |
| 621 | HB1 | ALA | 43 | 6.614 | 4.151 | −0.120 | 0.00 | 0.00 |
| 622 | HB2 | ALA | 43 | 5.241 | 5.187 | 0.329 | 0.00 | 0.00 |
| 623 | HB3 | ALA | 43 | 5.196 | 3.447 | 0.676 | 0.00 | 0.00 |
| 624 | N | GLU | 44 | 4.709 | 6.060 | −2.621 | 0.00 | 0.00 |
| 625 | CA | GLU | 44 | 5.205 | 7.211 | −3.370 | 0.00 | 0.00 |
| 626 | C | GLU | 44 | 6.151 | 8.029 | −2.480 | 0.00 | 0.00 |
| 627 | O | GLU | 44 | 5.730 | 8.764 | −1.587 | 0.00 | 0.00 |
| 628 | CB | GLU | 44 | 4.034 | 8.034 | −3.938 | 0.00 | 0.00 |
| 629 | CG | GLU | 44 | 4.534 | 9.279 | −4.688 | 0.00 | 0.00 |
| 630 | CD | GLU | 44 | 3.417 | 10.161 | −5.261 | 0.00 | 0.00 |
| 631 | OE1 | GLU | 44 | 2.267 | 9.729 | −5.481 | 0.00 | 0.00 |
| 632 | OE2 | GLU | 44 | 3.654 | 11.353 | −5.574 | 0.00 | 0.00 |
| 633 | H | GLU | 44 | 3.876 | 6.203 | −2.054 | 0.00 | 0.00 |
| 634 | HA | GLU | 44 | 5.781 | 6.851 | −4.221 | 0.00 | 0.00 |
| 635 | HB2 | GLU | 44 | 3.465 | 7.406 | −4.625 | 0.00 | 0.00 |
| 636 | HB3 | GLU | 44 | 3.379 | 8.340 | −3.126 | 0.00 | 0.00 |
| 637 | HG2 | GLU | 44 | 5.132 | 9.892 | −4.013 | 0.00 | 0.00 |
| 638 | HG3 | GLU | 44 | 5.180 | 8.952 | −5.506 | 0.00 | 0.00 |
| 639 | N | ASP | 45 | 7.446 | 7.909 | −2.756 | 0.00 | 0.00 |
| 640 | CA | ASP | 45 | 8.539 | 8.660 | −2.138 | 0.00 | 0.00 |
| 641 | C | ASP | 45 | 8.991 | 9.809 | −3.060 | 0.00 | 0.00 |
| 642 | O | ASP | 45 | 10.184 | 10.043 | −3.233 | 0.00 | 0.00 |
| 643 | CB | ASP | 45 | 9.684 | 7.682 | −1.813 | 0.00 | 0.00 |
| 644 | CG | ASP | 45 | 10.732 | 8.284 | −0.878 | 0.00 | 0.00 |
| 645 | OD1 | ASP | 45 | 10.382 | 9.124 | −0.022 | 0.00 | 0.00 |
| 646 | OD2 | ASP | 45 | 11.935 | 7.917 | −0.921 | 0.00 | 0.00 |
| 647 | H | ASP | 45 | 7.710 | 7.332 | −3.547 | 0.00 | 0.00 |
| 648 | HA | ASP | 45 | 8.183 | 9.105 | −1.208 | 0.00 | 0.00 |
| 649 | HB2 | ASP | 45 | 9.268 | 6.802 | −1.323 | 0.00 | 0.00 |
| 650 | HB3 | ASP | 45 | 10.158 | 7.369 | −2.744 | 0.00 | 0.00 |
| 651 | N | ALA | 46 | 8.050 | 10.448 | −3.766 | 0.00 | 0.00 |
| 652 | CA | ALA | 46 | 8.329 | 11.302 | −4.922 | 0.00 | 0.00 |
| 653 | C | ALA | 46 | 9.250 | 12.491 | −4.583 | 0.00 | 0.00 |
| 654 | O | ALA | 46 | 8.874 | 13.340 | −3.773 | 0.00 | 0.00 |
| 655 | CB | ALA | 46 | 7.000 | 11.798 | −5.505 | 0.00 | 0.00 |
| 656 | H | ALA | 46 | 7.089 | 10.204 | −3.582 | 0.00 | 0.00 |
| 657 | HA | ALA | 46 | 8.779 | 10.699 | −5.697 | 0.00 | 0.00 |
| 658 | HB1 | ALA | 46 | 6.435 | 10.956 | −5.900 | 0.00 | 0.00 |
| 659 | HB2 | ALA | 46 | 6.414 | 12.305 | −4.737 | 0.00 | 0.00 |
| 660 | HB3 | ALA | 46 | 7.194 | 12.495 | −6.321 | 0.00 | 0.00 |
| 661 | N | ALA | 47 | 10.418 | 12.708 | −5.196 | 0.00 | 0.00 |
| 662 | CA | ALA | 47 | 11.450 | 11.842 | −5.794 | 0.00 | 0.00 |
| 663 | C | ALA | 47 | 11.092 | 10.583 | −6.615 | 0.00 | 0.00 |
| 664 | O | ALA | 47 | 11.156 | 10.634 | −7.843 | 0.00 | 0.00 |
| 665 | CB | ALA | 47 | 12.556 | 11.583 | −4.759 | 0.00 | 0.00 |
| 666 | H | ALA | 47 | 10.760 | 13.641 | −5.011 | 0.00 | 0.00 |
| 667 | HA | ALA | 47 | 11.918 | 12.486 | −6.539 | 0.00 | 0.00 |
| 668 | HB1 | ALA | 47 | 12.257 | 10.852 | −4.017 | 0.00 | 0.00 |
| 669 | HB2 | ALA | 47 | 13.429 | 11.201 | −5.279 | 0.00 | 0.00 |
| 670 | HB3 | ALA | 47 | 12.821 | 12.503 | −4.241 | 0.00 | 0.00 |
| 671 | N | ALA | 48 | 10.839 | 9.437 | −5.975 | 0.00 | 0.00 |
| 672 | CA | ALA | 48 | 10.743 | 8.119 | −6.619 | 0.00 | 0.00 |
| 673 | C | ALA | 48 | 9.568 | 7.271 | −6.086 | 0.00 | 0.00 |
| 674 | O | ALA | 48 | 8.756 | 7.733 | −5.288 | 0.00 | 0.00 |
| 675 | CB | ALA | 48 | 12.095 | 7.415 | −6.415 | 0.00 | 0.00 |
| 676 | H | ALA | 48 | 10.731 | 9.473 | −4.965 | 0.00 | 0.00 |
| 677 | HA | ALA | 48 | 10.586 | 8.243 | −7.692 | 0.00 | 0.00 |
| 678 | HB1 | ALA | 48 | 12.261 | 7.221 | −5.353 | 0.00 | 0.00 |
| 679 | HB2 | ALA | 48 | 12.121 | 6.470 | −6.959 | 0.00 | 0.00 |
| 680 | HB3 | ALA | 48 | 12.900 | 8.042 | −6.797 | 0.00 | 0.00 |
| 681 | N | ILE | 49 | 9.486 | 6.008 | −6.514 | 0.00 | 0.00 |
| 682 | CA | ILE | 49 | 8.660 | 4.970 | −5.877 | 0.00 | 0.00 |
| 683 | C | ILE | 49 | 9.583 | 4.047 | −5.069 | 0.00 | 0.00 |
| 684 | O | ILE | 49 | 10.698 | 3.750 | −5.509 | 0.00 | 0.00 |
| 685 | CB | ILE | 49 | 7.825 | 4.202 | −6.930 | 0.00 | 0.00 |
| 686 | CG1 | ILE | 49 | 6.933 | 5.125 | −7.798 | 0.00 | 0.00 |
| 687 | CG2 | ILE | 49 | 6.968 | 3.097 | −6.283 | 0.00 | 0.00 |
| 688 | CD1 | ILE | 49 | 5.921 | 5.991 | −7.034 | 0.00 | 0.00 |
| 689 | H | ILE | 49 | 10.199 | 5.682 | −7.151 | 0.00 | 0.00 |
| 690 | HA | ILE | 49 | 7.967 | 5.432 | −5.173 | 0.00 | 0.00 |
| 691 | HB | ILE | 49 | 8.522 | 3.708 | −7.610 | 0.00 | 0.00 |
| 692 | 2HG1 | ILE | 49 | 7.571 | 5.786 | −8.385 | 0.00 | 0.00 |
| 693 | 3HG1 | ILE | 49 | 6.384 | 4.507 | −8.509 | 0.00 | 0.00 |
| 694 | 1HG2 | ILE | 49 | 6.338 | 3.511 | −5.496 | 0.00 | 0.00 |
| 695 | 2HG2 | ILE | 49 | 6.334 | 2.630 | −7.037 | 0.00 | 0.00 |
| 696 | 3HG2 | ILE | 49 | 7.605 | 2.322 | −5.857 | 0.00 | 0.00 |
| 697 | 1HD1 | ILE | 49 | 6.443 | 6.704 | −6.398 | 0.00 | 0.00 |
| 698 | 2HD1 | ILE | 49 | 5.314 | 6.547 | 7.748 | 0.00 | 0.00 |
| 699 | 3HD1 | ILE | 49 | 5.263 | 5.370 | −6.426 | 0.00 | 0.00 |
| 700 | N | ILE | 50 | 9.135 | 3.587 | −3.898 | 0.00 | 0.00 |
| 701 | CA | ILE | 50 | 9.873 | 2.624 | −3.064 | 0.00 | 0.00 |
| 702 | C | ILE | 50 | 9.011 | 1.414 | −2.702 | 0.00 | 0.00 |
| 703 | O | ILE | 50 | 7.784 | 1.501 | −2.646 | 0.00 | 0.00 |
| 704 | CB | ILE | 50 | 10.489 | 3.283 | −1.806 | 0.00 | 0.00 |
| 705 | CG1 | ILE | 50 | 9.427 | 3.727 | −0.776 | 0.00 | 0.00 |
| 706 | CG2 | ILE | 50 | 11.436 | 4.423 | −2.210 | 0.00 | 0.00 |
| 707 | CD1 | ILE | 50 | 10.029 | 4.235 | 0.539 | 0.00 | 0.00 |
| 708 | H | ILE | 50 | 8.207 | 3.868 | −3.591 | 0.00 | 0.00 |
| 709 | HA | ILE | 50 | 10.706 | 2.233 | −3.649 | 0.00 | 0.00 |
| 710 | HB | ILE | 50 | 11.105 | 2.523 | −1.322 | 0.00 | 0.00 |
| 711 | 2HG1 | ILE | 50 | 8.799 | 4.506 | −1.208 | 0.00 | 0.00 |
| 712 | 3HG1 | ILE | 50 | 8.790 | 2.879 | −0.527 | 0.00 | 0.00 |
| 713 | 1HG2 | ILE | 50 | 10.874 | 5.248 | −2.639 | 0.00 | 0.00 |
| 714 | 2HG2 | ILE | 50 | 11.992 | 4.782 | −1.344 | 0.00 | 0.00 |
| 715 | 3HG2 | ILE | 50 | 12.147 | 4.065 | −2.952 | 0.00 | 0.00 |
| 716 | 1HD1 | ILE | 50 | 10.527 | 5.192 | 0.386 | 0.00 | 0.00 |
| 717 | 2HD1 | ILE | 50 | 9.231 | 4.368 | 1.269 | 0.00 | 0.00 |
| 718 | 3HD1 | ILE | 50 | 10.743 | 3.509 | 0.928 | 0.00 | 0.00 |
| 719 | N | ALA | 51 | 9.677 | 0.297 | −2.407 | 0.00 | 0.00 |
| 720 | CA | ALA | 51 | 9.059 | −0.896 | −1.842 | 0.00 | 0.00 |
| 721 | C | ALA | 51 | 9.447 | −1.057 | −0.360 | 0.00 | 0.00 |
| 722 | O | ALA | 51 | 10.632 | −1.004 | −0.004 | 0.00 | 0.00 |
| 723 | CB | ALA | 51 | 9.415 | −2.110 | −2.709 | 0.00 | 0.00 |
| 724 | H | ALA | 51 | 10.684 | 0.308 | −2.471 | 0.00 | 0.00 |
| 725 | HA | ALA | 51 | 7.978 | −0.782 | −1.892 | 0.00 | 0.00 |
| 726 | HB1 | ALA | 51 | 10.491 | −2.265 | −2.732 | 0.00 | 0.00 |
| 727 | HB2 | ALA | 51 | 8.930 | −2.998 | −2.305 | 0.00 | 0.00 |
| 728 | HB3 | ALA | 51 | 9.058 | −1.950 | −3.727 | 0.00 | 0.00 |
| 729 | N | LEU | 52 | 8.450 | −1.261 | 0.497 | 0.00 | 0.00 |
| 730 | CA | LEU | 52 | 8.585 | −1.449 | 1.944 | 0.00 | 0.00 |
| 731 | C | LEU | 52 | 8.295 | −2.908 | 2.312 | 0.00 | 0.00 |
| 732 | O | LEU | 52 | 7.382 | −3.517 | 1.757 | 0.00 | 0.00 |
| 733 | CB | LEU | 52 | 7.653 | −0.479 | 2.697 | 0.00 | 0.00 |
| 734 | CG | LEU | 52 | 7.949 | 1.018 | 2.478 | 0.00 | 0.00 |
| 735 | CD1 | LEU | 52 | 6.901 | 1.864 | 3.201 | 0.00 | 0.00 |
| 736 | CD2 | LEU | 52 | 9.330 | 1.414 | 3.007 | 0.00 | 0.00 |
| 737 | H | LEU | 52 | 7.523 | −1.398 | 0.103 | 0.00 | 0.00 |
| 738 | HA | LEU | 52 | 9.610 | −1.240 | 2.242 | 0.00 | 0.00 |
| 739 | HB2 | LEU | 52 | 6.627 | −0.680 | 2.386 | 0.00 | 0.00 |
| 740 | HB3 | LEU | 52 | 7.721 | −0.693 | 3.765 | 0.00 | 0.00 |
| 741 | HG | LEU | 52 | 7.898 | 1.252 | 1.414 | 0.00 | 0.00 |
| 742 | 1HD1 | LEU | 52 | 6.936 | 1.674 | 4.273 | 0.00 | 0.00 |
| 743 | 2HD1 | LEU | 52 | 7.085 | 2.922 | 3.015 | 0.00 | 0.00 |
| 744 | 3HD1 | LEU | 52 | 5.906 | 1.615 | 2.830 | 0.00 | 0.00 |
| 745 | 1HD2 | LEU | 52 | 10.106 | 0.944 | 2.406 | 0.00 | 0.00 |
| 746 | 2HD2 | LEU | 52 | 9.455 | 2.494 | 2.946 | 0.00 | 0.00 |
| 747 | 3HD2 | LEU | 52 | 9.435 | 1.102 | 4.047 | 0.00 | 0.00 |
| 748 | N | ALA | 53 | 9.056 | −3.462 | 3.251 | 0.00 | 0.00 |
| 749 | CA | ALA | 53 | 8.918 | −4.851 | 3.691 | 0.00 | 0.00 |
| 750 | C | ALA | 53 | 8.817 | −4.958 | 5.220 | 0.00 | 0.00 |
| 751 | O | ALA | 53 | 9.310 | −4.095 | 5.954 | 0.00 | 0.00 |
| 752 | CB | ALA | 53 | 10.072 | −5.675 | 3.110 | 0.00 | 0.00 |
| 753 | H | ALA | 53 | 9.769 | −2.898 | 3.700 | 0.00 | 0.00 |
| 754 | HA | ALA | 53 | 7.990 | −5.265 | 3.289 | 0.00 | 0.00 |
| 755 | HB1 | ALA | 53 | 11.023 | −5.286 | 3.473 | 0.00 | 0.00 |
| 756 | HB2 | ALA | 53 | 9.978 | −6.718 | 3.415 | 0.00 | 0.00 |
| 757 | HB3 | ALA | 53 | 10.058 | −5.618 | 2.021 | 0.00 | 0.00 |
| 758 | N | VAL | 54 | 8.155 | −6.031 | 5.671 | 0.00 | 0.00 |
| 759 | CA | VAL | 54 | 7.906 | −6.371 | 7.087 | 0.00 | 0.00 |
| 760 | C | VAL | 54 | 9.204 | −6.528 | 7.876 | 0.00 | 0.00 |
| 761 | O | VAL | 54 | 10.204 | −7.008 | 7.307 | 0.00 | 0.00 |
| 762 | CB | VAL | 54 | 7.008 | −7.620 | 7.179 | 0.00 | 0.00 |
| 763 | CG1 | VAL | 54 | 6.714 | −8.039 | 8.624 | 0.00 | 0.00 |
| 764 | CG2 | VAL | 54 | 5.654 | −7.363 | 6.500 | 0.00 | 0.00 |
| 765 | OXT | VAL | 54 | 9.212 | −6.124 | 9.064 | 0.00 | 0.00 |
| 766 | H | VAL | 54 | 7.796 | −6.668 | 4.978 | 0.00 | 0.00 |
| 767 | HA | VAL | 54 | 7.374 | −5.539 | 7.541 | 0.00 | 0.00 |
| 768 | HB | VAL | 54 | 7.504 | −8.449 | 6.674 | 0.00 | 0.00 |
| 769 | 1HG1 | VAL | 54 | 6.305 | −7.197 | 9.184 | 0.00 | 0.00 |
| 770 | 2HG1 | VAL | 54 | 6.001 | −8.863 | 8.641 | 0.00 | 0.00 |
| 771 | 3HG1 | VAL | 54 | 7.629 | −8.379 | 9.105 | 0.00 | 0.00 |
| 772 | 1HG2 | VAL | 54 | 5.787 | −7.145 | 5.442 | 0.00 | 0.00 |
| 773 | 2HG2 | VAL | 54 | 5.020 | −8.244 | 6.589 | 0.00 | 0.00 |
| 774 | 3HG2 | VAL | 54 | 5.156 | −6.518 | 6.977 | 0.00 | 0.00 |
| 775 | C1 | MOL | 55 | 5.377 | 0.222 | 7.146 | 0.00 | 0.00 |
| 776 | C2 | MOL | 55 | 4.946 | 2.587 | 6.788 | 0.00 | 0.00 |
| 777 | C3 | MOL | 55 | 5.848 | 1.472 | 7.037 | 0.00 | 0.00 |
| 778 | C4 | MOL | 55 | 6.039 | −1.018 | 7.472 | 0.00 | 0.00 |
| 779 | C5 | MOL | 55 | 5.100 | −1.949 | 7.680 | 0.00 | 0.00 |
| 780 | C6 | MOL | 55 | 3.700 | −1.370 | 7.588 | 0.00 | 0.00 |
| 781 | C9 | MOL | 55 | 5.157 | 3.931 | 6.645 | 0.00 | 0.00 |
| 782 | C11 | MOL | 55 | 2.961 | 3.545 | 6.326 | 0.00 | 0.00 |
| 783 | C12 | MOL | 55 | 3.906 | 4.536 | 6.353 | 0.00 | 0.00 |
| 784 | C14 | MOL | 55 | 7.537 | −1.195 | 7.451 | 0.00 | 0.00 |
| 785 | N18 | MOL | 55 | 4.019 | −0.045 | 7.037 | 0.00 | 0.00 |
| 786 | N19 | MOL | 55 | 3.591 | 2.356 | 6.660 | 0.00 | 0.00 |
| 787 | C20 | MOL | 55 | 3.004 | 1.015 | 6.863 | 0.00 | 0.00 |
| 788 | C23 | MOL | 55 | 1.554 | 3.743 | 5.820 | 0.00 | 0.00 |
| 789 | C26 | MOL | 55 | 0.481 | 3.753 | 6.931 | 0.00 | 0.00 |
| 790 | C29 | MOL | 55 | −0.886 | 3.439 | 6.367 | 0.00 | 0.00 |
| 791 | O30 | MOL | 55 | −1.279 | 3.845 | 5.291 | 0.00 | 0.00 |
| 792 | O31 | MOL | 55 | −1.538 | 2.523 | 7.111 | 0.00 | 0.00 |
| 793 | C32 | MOL | 55 | −2.523 | 1.648 | 6.484 | 0.00 | 0.00 |
| 794 | C34 | MOL | 55 | −1.850 | 0.356 | 5.957 | 0.00 | 0.00 |
| 795 | C39 | MOL | 55 | 2.750 | −2.130 | 6.695 | 0.00 | 0.00 |
| 796 | C41 | MOL | 55 | 1.728 | −2.854 | 7.185 | 0.00 | 0.00 |
| 797 | C43 | MOL | 55 | 0.655 | −3.487 | 6.380 | 0.00 | 0.00 |
| 798 | C44 | MOL | 55 | 0.264 | −2.923 | 5.159 | 0.00 | 0.00 |
| 799 | C45 | MOL | 55 | −0.050 | −4.595 | 6.870 | 0.00 | 0.00 |
| 800 | C46 | MOL | 55 | −0.813 | −3.450 | 4.445 | 0.00 | 0.00 |
| 801 | C48 | MOL | 55 | −1.103 | −5.143 | 6.134 | 0.00 | 0.00 |
| 802 | C49 | MOL | 55 | −1.496 | −4.561 | 4.931 | 0.00 | 0.00 |
| 803 | O52 | MOL | 55 | −1.786 | −6.246 | 6.605 | 0.00 | 0.00 |
| 804 | C53 | MOL | 55 | −1.206 | −7.562 | 6.456 | 0.00 | 0.00 |
| 805 | C56 | MOL | 55 | −2.238 | −8.598 | 6.922 | 0.00 | 0.00 |
| 806 | O60 | MOL | 55 | 0.236 | −5.151 | 8.079 | 0.00 | 0.00 |
| 807 | 6C13 | MOL | 55 | −0.808 | −0.344 | 7.231 | 0.00 | 0.00 |
| 808 | 7C13 | MOL | 55 | −0.885 | 0.674 | 4.485 | 0.00 | 0.00 |
| 809 | 8C13 | MOL | 55 | −3.115 | −0.837 | 5.557 | 0.00 | 0.00 |
| 810 | F21 | MOL | 55 | 2.250 | 0.654 | 5.811 | 0.00 | 0.00 |
| 811 | F22 | MOL | 55 | 2.224 | 0.997 | 7.959 | 0.00 | 0.00 |
| 812 | H7 | MOL | 55 | 6.907 | 1.680 | 7.164 | 0.00 | 0.00 |
| 813 | H8 | MOL | 55 | 5.280 | −2.993 | 7.922 | 0.00 | 0.00 |
| 814 | H10 | MOL | 55 | 6.109 | 4.449 | 6.697 | 0.00 | 0.00 |
| 815 | H13 | MOL | 55 | 3.757 | 5.586 | 6.124 | 0.00 | 0.00 |
| 816 | H15 | MOL | 55 | 7.991 | −0.640 | 6.628 | 0.00 | 0.00 |
| 817 | H16 | MOL | 55 | 7.982 | −0.844 | 8.385 | 0.00 | 0.00 |
| 818 | H17 | MOL | 55 | 7.801 | −2.248 | 7.330 | 0.00 | 0.00 |
| 819 | H24 | MOL | 55 | 1.479 | 4.675 | 5.256 | 0.00 | 0.00 |
| 820 | H25 | MOL | 55 | 1.327 | 2.951 | 5.102 | 0.00 | 0.00 |
| 821 | H27 | MOL | 55 | 0.452 | 4.721 | 7.431 | 0.00 | 0.00 |
| 822 | H28 | MOL | 55 | 0.722 | 3.006 | 7.688 | 0.00 | 0.00 |
| 823 | H33 | MOL | 55 | −3.043 | 2.166 | 5.673 | 0.00 | 0.00 |
| 824 | H35 | MOL | 55 | −3.256 | 1.368 | 7.244 | 0.00 | 0.00 |
| 825 | H40 | MOL | 55 | 2.892 | −1.995 | 5.627 | 0.00 | 0.00 |
| 826 | H42 | MOL | 55 | 1.606 | −2.971 | 8.262 | 0.00 | 0.00 |
| 827 | H47 | MOL | 55 | 0.772 | −2.044 | 4.775 | 0.00 | 0.00 |
| 828 | H50 | MOL | 55 | −1.120 | −2.985 | 3.512 | 0.00 | 0.00 |
| 829 | H51 | MOL | 55 | −2.344 | −4.966 | 4.386 | 0.00 | 0.00 |
| 830 | H54 | MOL | 55 | −0.955 | −7.730 | 5.406 | 0.00 | 0.00 |
| 831 | H55 | MOL | 55 | −0.297 | −7.636 | 7.059 | 0.00 | 0.00 |
| 832 | H57 | MOL | 55 | −1.845 | −9.609 | 6.793 | 0.00 | 0.00 |
| 833 | H58 | MOL | 55 | −2.478 | −8.452 | 7.978 | 0.00 | 0.00 |
| 834 | H59 | MOL | 55 | −3.158 | −8.509 | 6.341 | 0.00 | 0.00 |
| 835 | H61 | MOL | 55 | −0.511 | −5.756 | 8.250 | 0.00 | 0.00 |
| 836 | H62 | MOL | 55 | 3.280 | −1.266 | 8.595 | 0.00 | 0.00 |
| 837 | Na+ | Na+ | 56 | −16.406 | −2.134 | −3.920 | 0.00 | 0.00 |
| 838 | Na+ | Na+ | 57 | 12.376 | 9.424 | 0.723 | 0.00 | 0.00 |
| 839 | Na+ | Na+ | 58 | 9.203 | −7.223 | −5.015 | 0.00 | 0.00 |
| 840 | Na+ | Na+ | 59 | 1.622 | 11.506 | −6.532 | 0.00 | 0.00 |
| 841 | Na+ | Na+ | 60 | −14.438 | 6.714 | 2.327 | 0.00 | 0.00 |

Thermodynamic Calculations for BD-Oligo Complex with Aβ Oligomer.

To further characterize the molecular origin and binding affinity upon complexation of BD-Oligo with Aβ oligomer, we computed the changes in total internal energy (ΔEu), solvation free energy (ΔGsolv), and free energy (Δf) upon its complexation. The internal energy was directly computed from the force field used for the simulations, whereas the solvation free energy was calculated using the integralequation theory of liquids. By combining the internal energy and solvation free energy, we obtain the free energy (f=Eu+Gsolv). The binding free energy upon BD-Oligo complexation with Aβ oligomer is computed to be −27.2 kcal/mol in aqueous environments. On the basis of the site-directed thermodynamics analysis of the binding free energy, it is evident that the hydrophobic residues of F19/V36 in Aβ oligomer contribute most distinctively to the binding free energy upon complexation (FIG. 10). Thermodynamic analysis based on the simulated complex structure confirms that the hydrophobic patches of F19/V36 in Aβ oligomer are the main contributors to recognize BD-Oligo in aqueous environments.

Aβ Oligomer Staining with BD-Oligo in Live AD Brain.

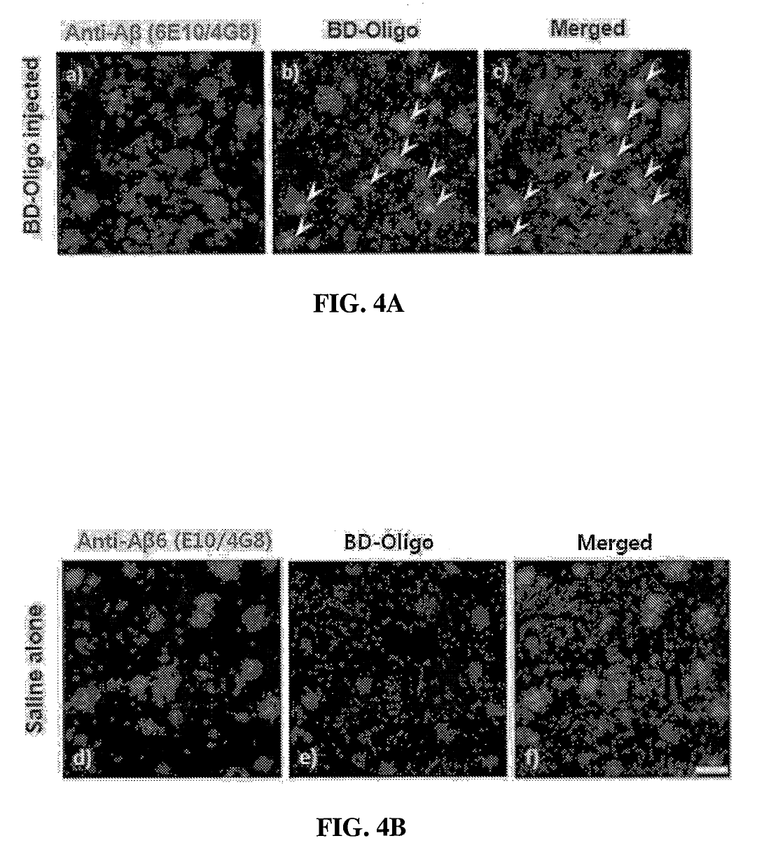

Encouraged by the in vitro findings, we further investigate the oligomer detection ability of BD-Oligo in biological sample using a set of brain tissue fluorescence imaging experiments. Immunofluorescence analysis of 18 month old APP/PS1 transgenic (Tg) mouse brain with anti-Aβ (6E10/4G8) antibody showed that extracellular Aβ deposition is evident. In addition, 6E10/4G8 also identified sites of Aβ intracellular accumulation (FIG. 4A). Intraperitoneal (ip) injection of BDOligo resulted in fluorescent labeling of AD brain tissue of APP/PS 1 Tg mice, which indicates that BD-Oligo is able to cross the BBB and that there is no apparent toxicity associated with in vivo injection. Interestingly, BD-Oligo labeling not only appeared in the central core of the plaques but is also present in the less compacted periphery of plaques indicating oligomer staining (FIG. 4B). In addition, there appeared to be some punctate, possibly intraneuronal staining with BD-Oligo surrounding plaques, which had brighter intensity than the endogenous autofluorescence present in the control APP/PS1Tg mouse brains. FIG. 4c indicated the labeling of BDOligo, which colocalized with the labeling using anti-Aβ antibodies 4G8/6E10. Fluorescent staining was not present in the APP/PS 1 mouse injected with saline alone (FIG. 4e). Taken together, BD-Oligo successfully penetrates the BBB to show Aβ oligomers detection capabilities in the brains of the AD transgenic mice model without toxicity.

### Discussion

Studies over the past decade have suggested that oligomers of Aβ are now thought to play a central role in neurodegeneration in Alzheimer's disease. Despite the great personal and economic toll associated with the disease, progress in developing effective treatments remains slow. A significant factor is the lack of powerful diagnostic methods, especially for the earliest stage of Alzheimer's disease, which are needed for effective disease intervention and management. BD-Oligo was found through a systematic screening of 3500 fluorescent compounds selected from our in-house diversityoriented fluorescence libraries. DOFL has shed light on sensor development in the past decade. The rationale for adopting such a tedious approach is due to the lack of mechanistic cues to rationally design a probe for Aβ oligomers. While the structures of Aβ fibrils are relatively well understood, knowledge regarding the structures of oligomers is still limited, largely due to their heterogeneous and transient nature. Our results show that BD-Oligo is capable of differentiating Aβ oligomers-containing samples from controls as well as the versatility of detecting Aβ oligomeric species on-fibril pathway during Aβ fibril formation. The hydrophobic central and C-terminal regions of Aβ are known to participate in aggregation to form fibrils and are likely involved in the aggregation of oligomers. Although many molecular details of the aggregation processes are yet to be elucidated, the formation of β-sheets appears to be involved. In the current study, biophysical characterization of Aβ peptide sample during fibrillogenesis renders the presence of β-sheet structure alone insufficient to explain the binding specificity of BD-Oligo. Whatever assembly state or conformational change of Aβ BD-Oligo may recognize exists in soluble, prefibrillar Aβ aggregates. It is believed that aggregated Aβ peptides which have not attained the final mature form of an amyloid fibril display exposed hydrophobic patches. In fact, 4,4-bis-1-phenylamino-8-naphthalenesulfonate (bis-ANS) was shown to bind oligomeric intermediates, which has been widely used in the protein folding field for many decades as a marker for surface-exposed hydrophobic patches and molten-globule-like characteristics.

Moreover, MD simulations for the complex of BD-Oligo and Aβ oligomers revealed the main binding mode to be π-π-stacking interactions in addition to H bonding between BD-Oligo and the exposed hydrophobic patches of Aβ oligomers. The proposed interactions are deemed oligomer specific, since the hydrophobic patches are exposed to solvent only in Aβ oligomers but not in Aβ fibrils or Aβ monomer. As most BODIPY dyes tend to form aggregates in polar solutions due to their relatively hydrophobic nature, we postulate that the interaction of BD-Oligo and Aβ oligomers is strong enough to disassemble BD-Oligo aggregates, which subsequently manifests as an enhancement in fluorescence signal.

It has been suggested that insoluble amyloid plaques may represent a reservoir that releases toxic soluble oligomers. We postulate that the tissue staining pattern is a reflection of this phenomenon, where BD-Oligo-labeled-soluble Aβ intermediates are associated with plaque cores, as well as with the periphery of plaques. Further support for this hypothesis is provided by the observation of a halo of enlarged, abnormal neuronal processes surrounding amyloid plaques, suggesting that the source of synaptoxicity resides within the plaque and can diffuse to distant locations. Moreover, considering the fact that the kinetic data (FIG. 2) shows BD-Oligo to be labeling later assembly states of Aβ while A11 recognizes earlier prefibrillar, Aβ oligomers, it may explain why our probe labeling is associated with plaques and the periphery of such areas. On the other hand, it is also possible that BD-Oligo labels the transient, unstable oligomer species on transition to elongating fibrils, which may be present in the amyloid plaques and its periphery.

### CONCLUSION

In summary, through high-content DOFL screening, we discovered BD-Oligo as a promising fluorescence sensor for the detection of Aβ oligomers. BD-Oligo demonstrated dynamic oligomer monitoring during Aβ fibrillogenesis, as Aβ peptide was induced to form fibrils over time. The sensing process is based on π-π-stacking interactions in addition to H bonding between BD-Oligo and the exposed hydrophobic patches of Aβ oligomers, as determined by computational techniques. BD-Oligo is able to cross the BBB to give rise to oligomers detection in the brains of AD transgenic mice model without toxicity. Imaging agents than can detect Aβ oligomers in vivo are believed to be essential for disease diagnosis, progress, and medical treatment monitoring and are therefore greatly needed. As such, BD-Oligo provides a good starting point for further probe development applicable in the studies and to assist the research of AD associated with oligomer sensing.

What is claimed is:

1. A screening method of a composition for preventing or treating or diagnosing protein conformational diseases comprising the following steps:
(a) contacting peptide represented by the following Formula 1 and a test material to be analyzed:
[(X₁)ₙ-X₃-X₄-Phe-X₅-X₆-X₇-X₈-(X₂)n-X₉-X₁₀-X₁₁-X₁₂-X₁₃-X₁₄-Val]ₘ Formula 1
in Formula 1, X₁ and X₂ are independently selected from the group consisting of ALA, GLY, and SER, respectively, X₃ to X₁₄ are independently selected from the group consisting of ALA, GLU, ILE, VAL, ASP, and LEU, respectively, and n is an integer of 2 to 4, and m is an integer of 3 to 12; and
(b) measuring binding of the peptide and the test material to be analyzed, in which when the binding of the peptide and the test material to be analyzed is detected, the test material is determined as the composition for preventing or treating the protein conformational diseases.

2. The screening method according to claim 1, wherein the steps (a) and (b) are performed by using computational simulation.

3. The screening method according to claim 2, wherein the computational simulation is a molecular dynamic simulation.

4. The screening method according to claim 1, wherein the X₁ in Formula 1 is ALA.

5. The screening method according to claim 1, wherein the X₃, X₄, X₅, X₆, X₇ and X₈ in Formula 1 are independently selected from the group consisting of LEU, VAL, PHE, ALA, GLU, and ASP.

6. The screening method according to claim 1, wherein the X₃, X₄, X₅, X₆, X₇ and X₈ in Formula 1 are LEU, VAL, PHE, ALA, GLU, and ASP, respectively.

7. The screening method according to claim 1, wherein the X₉, X₁₀, X₁₁, X₁₂, X₁₃ and X₁₄ in Formula 1 are independently selected from the group consisting of ALA, ILE, and LEU.

8. The screening method according to claim 1, wherein the X₉, X₁₀, X₁₁, X₁₂, X₁₃ and X₁₄ in Formula 1 are ALA, ILE, ILE, ALA, LEU and ALA, respectively.

9. The screening method according to claim 1, wherein the N in Formula 1 is 2.

10. The screening method according to claim 1, wherein the m in Formula 1 is 3 or 12.

11. The screening method according to claim 1, wherein the m in Formula 1 is 3.

12. The screening method according to claim 9, wherein the PHE and C-terminal VAL between X₄ and X₅ in the Formula 1 has substantially the same coordinate as atom coordinate listed in Table 1 in the entire molecules.

13. The screening method according to claim 10, wherein the peptide has substantially the same coordinate as atom coordinate listed in Table 2.

14. The screening method according to claim 1, wherein the protein conformational disease is selected from the group consisting of Alzheimer's disease, Lewy body dementia, inclusion body myositis, and cerebral amyloid angiopathy.

15. The screening method according to claim 1, wherein the protein conformational disease is Alzheimer's disease.
